(19) United States
(12) Patent Application Publication
(10) Pub. No.: US 2023/0095186 A1
(43) Pub. Date: Mar. 30, 2023

(54) INFORMATION PROCESSING DEVICE, INFORMATION PROCESSING SYSTEM, AND INFORMATION PROCESSING METHOD

(71) Applicant: SONY GROUP CORPORATION, TOKYO (JP)

(72) Inventor: TAKEFUMI NAGUMO, KANAGAWA (JP)

(21) Appl. No.: 17/908,808

(22) PCT Filed: Mar. 4, 2021
(86) PCT No.: PCT/JP2021/008561

§ 371 Date: Sep. 1, 2022

(30) Foreign Application Priority Data
Mar. 11, 2020 (JP) 2020-042249

(51) Int. Cl. H04N 7/01; H04N 7/18; H04N 19/142; H04N 19/164; H04N 19/172; H04N 19/42

(52) U.S. Cl. CPC H04N 7/0117; H04N 7/0127; H04N 7/181; H04N 19/142; H04N 19/164; H04N 19/172; H04N 19/42

(57) ABSTRACT

An information processing device (10, 10A) includes a band requesting unit (162, 162A), an adjusting unit (164, 164A), and a transmitting unit (140). The band requesting unit (162, 162A) requests, according to a bandwidth necessary for transmitting information including a moving image, a use reservation of the bandwidth. The adjusting unit (164, 164A) adjusts, according to a result of the request by the band requesting unit and a reserved bandwidth, an information amount of information to be transmitted. The transmitting unit (140) converts the information with the adjusted information amount into a transmission signal and transmits the transmission signal.

### FIELD

The present disclosure relates to an information processing device, an information processing system, and an information processing method.

### BACKGROUND

There has been a wireless communication technique for exchanging various data using wireless communication. For example, in recent years, an application that accesses a mobile network game from a terminal device such as a smartphone via a wireless network has increased. There has been known a technique for two-dimensionally rendering a three-dimensional model when such an application transmits an image to the terminal device. In such a technique, a bit rate is intensively allocated to a gaze object by a user in a screen to transmit a high-quality image to the terminal device while reducing a processing load on the terminal device.

### CITATION LIST

### Patent Literature

Patent Literature 1: JP 2007-79664 A

### SUMMARY

### Technical Problem

However, the image quality of the image displayed on the terminal device fluctuates according to not only drawing performance of the terminal device but also a state of the wireless network between the application and the terminal device. If a band that can be used for image transmission cannot be sufficiently secured in the wireless network, there is a possibility that a delay in the image transmission, image quality deterioration, and the like are caused and usability is deteriorated.

Therefore, the present disclosure provides an information processing device, an information processing system, and an information processing method capable of suppressing deterioration in usability.

### Solution to Problem

According to the present disclosure, an information processing device is provided. The information processing device includes a band requesting unit, an adjusting unit, and a transmitting unit. The band requesting unit requests, according to a bandwidth necessary for transmitting information including a moving image, a use reservation of the bandwidth. The adjusting unit adjusts, according to a reserved bandwidth as a result of the request by the band requesting unit, an information amount of information to be transmitted. The transmitting unit converts the information with the adjusted information amount into a transmission signal and transmits the transmission signal.

### BRIEF DESCRIPTION OF DRAWINGS

FIG. 1 is a diagram for explaining an overview of a proposed technique of the present disclosure.

FIG. 2 is a diagram illustrating an example of a configuration of an information processing system according to a first embodiment of the present disclosure.

FIG. 3 is a diagram illustrating a configuration example of a control unit according to the first embodiment of the present disclosure.

FIG. 4 is a diagram for explaining an operation of an information processing device according to the first embodiment of the present disclosure.

FIG. 5 is a diagram for explaining a transmission method in a case where a transmission rate is constant.

FIG. 6 is a diagram for explaining the transmission method in the case where the transmission rate is constant.

FIG. 7 is a diagram for explaining an adjusting unit according to the first embodiment of the present disclosure.

FIG. 8 is a diagram for explaining a band requesting unit according to the first embodiment of the present disclosure.

FIG. 9 is a diagram for explaining another example of the operation of the information processing device according to the first embodiment of the present disclosure.

FIG. 10 is a flowchart illustrating a moving image transmission processing procedure according to the first embodiment of the present disclosure.

FIG. 11 is a diagram for explaining a band reservation request by a band requesting unit according to a first modification of the present disclosure.

FIG. 12 is a diagram for explaining a band reservation request by the band requesting unit according to the first modification of the present disclosure.

FIG. 13 is a diagram for explaining a band requesting unit according to a second modification of the present disclosure.

FIG. 14 is a diagram illustrating a configuration example of a remote control system according to a second embodiment of the present disclosure.

FIG. 15 is a block diagram illustrating a configuration example of an information processing device according to the second embodiment of the present disclosure.

FIG. 16 is a diagram for explaining an example of information to be adjusted by an adjusting unit according to the second embodiment of the present disclosure.

FIG. 17 is a diagram for explaining an operation example of the information processing device according to the second embodiment of the present disclosure.

FIG. 18 is a diagram illustrating a configuration example of an information processing device according to a third modification of the present disclosure.

FIG. 19 is a block diagram illustrating a schematic configuration example of a vehicle control system, which is an example of a mobile body control system to which a technique according to the second embodiment of the present disclosure can be applied.

FIG. 20 is a diagram illustrating an example of a setting position of an imaging unit.

### DESCRIPTION OF EMBODIMENTS

Preferred embodiments of the present disclosure are explained in detail below with reference to the accompanying drawings. Note that, in the present specification and the drawings, components having substantially the same functional configurations are denoted by the same reference numerals and signs, whereby redundant explanation of the components is omitted.

In the following explanation, for example, a numerical value is sometimes explained as a specific example. However, such a numerical value is an example and another numerical value may be used.

Note that the explanation is made in the following order.
1. Introduction
   1.1. Overview of a proposed technique
2. First Embodiment
   2.1. Information processing system
   2.2. Operation example of an information processing device
   2.3. Moving image transmission processing
3. First modification
4. Second modification
5. Second Embodiment
   5.1. Remote control system
   5.2. information processing device
   5.3. Operation example of the information processing device
6. Third modification
7. Application Example
8. Supplement

### 1. Introduction

<1.1. Overview of a Proposed Technique>

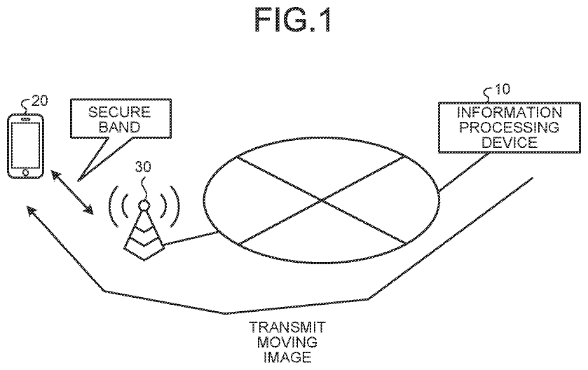

First, an overview of the proposed technique according to the present disclosure is explained. FIG. 1 is a diagram for explaining an overview of a proposed technique of the present disclosure. The proposed technique according to the present disclosure is implemented in an information processing system illustrated in FIG. 1. As illustrated in FIG. 1, the information processing system includes an information processing device 10, a terminal device 20, and a base station device 30.

The information processing device 10 is, for example, a game server and provides a service such as a game to the terminal device 20 via the base station device 30. For example, the information processing device 10 transmits a moving image such as a game image to the terminal device 20.

The terminal device 20 may be, for example, a smartphone, a PC, or a game device. The terminal device 20 displays the moving image acquired from the information processing device 10 on a display unit of the own device or a display device connected to the own device.

The base station device 30 is a wireless communication device that performs wireless communication with the terminal device 20. The base station device 30 is, for example, a device equivalent to a wireless base station (Node B, eNB, gNB, or the like) and provides a cellular communication service such as NR (New Radio) to the terminal device 20. The base station device 30 may be a wireless relay station. The base station device 30 may be an on-road base station device such as an RSU (Road Side Unit). The base station device 30 may be an optical extension device called RRH (Remote Radio Head).

The base station device 30 is connected to the information processing device 10 via, for example, a network and transmits information concerning a service provided by the information processing device 10 such as a moving image of a game to the terminal device 20. The base station device 30 provides game operation information and the like by the terminal device 20 to the information processing device 10 via a network.

As explained above, the information processing device 10 and the terminal device 20 transmit and receive information via the base station device 30, whereby the terminal device 20 can receive provision of a service such as a Cloud game from the information processing device 10.

As explained above, the terminal device 20 and the base station device 30 are connected by, for example, wireless communication. In the wireless communication, a communication state changes according to a communication environment or a congestion degree of data to be transmitted and a transmission band available for the wireless communication is not constant. Therefore, there is a problem in that a transmission rate becomes unstable. When an amount of information to be transmitted is large as in a game service or the like for transmitting a moving image, it is likely that the transmission rate being unstable as explained above causes a delay of the moving image, deterioration in image quality, and the like and usability is deteriorated.

On the other hand, when the communication between the base station device 30 and the terminal device 20 is fifth generation mobile communication (5G), the base station device 30 can secure a certain band used for communication with the terminal device 20. Therefore, in 5G, when transmitting a moving image to the terminal device 20, the information processing device 10 can secure a desired band between the base station device 30 and the terminal device 20. As explained above, by securing, in advance, the band necessary for the information processing device 10 to transmit a high-quality moving image, the information processing device 10 can suppress transmission delay, image quality deterioration, and the like of the moving image and can suppress deterioration in usability.

However, if a time in which the information processing device 10 secures a band is long, use efficiency of a frequency band decreases and communication cost increases.

Therefore, in the proposed technology, the information processing device 10 dynamically secures a band according to, for example, a game state and a transmission state of a moving image. Consequently, it is possible to suppress a transmission delay of a moving image, image quality deterioration, and the like while suppressing an increase in communication cost and it is possible to suppress deterioration in usability.

### 2. First Embodiment

<2.1. Information Processing System>

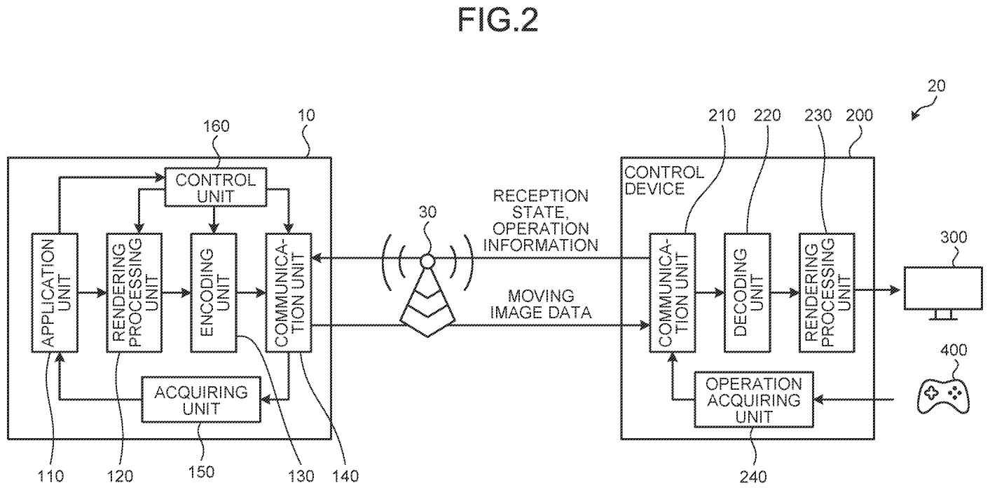

FIG. 2 is a diagram illustrating an example of a configuration of an information processing system according to a first embodiment of the present disclosure. As explained above, the information processing system includes the information processing device 10, the terminal device 20, and the base station device 30.

[Terminal Device 20]

As illustrated in FIG. 2, the terminal device 20 includes a control device 200, a display device (Monitor) 300, and an operation device (Controller) 400. Note that the configuration of the terminal device 20 is not limited to the configuration illustrated in FIG. 2 and may be another configuration if the terminal device 20 is configured to perform information processing explained below. For example, like a smartphone, the terminal device 20 may have a configuration in which the control device 200, the display device 300, and the operation device 400 are disposed in one housing.

(Control Device 200)

The control device 200 receives moving image data related to a game transmitted from the information processing device 10 and displays the received moving image data on the display device 300. The control device 200 notifies a reception state of the moving image data to the information processing device 10. The reception state includes reception error information indicating that the control device 200 has failed in receiving the moving image data. The control device 200 acquires operation for the game by a user via the operation device 400. The control device 200 transmits the acquired operation to the information processing device 10 as operation information.

The control device 200 includes a communication unit 210, a decoding unit 220, a rendering processing unit 230, and an operation acquiring unit 240.

(Communication Unit 210)

The communication unit 210 is a communication interface (I/F) that communicates with an external device. The communication unit 210 is realized by, for example, an NIC (Network Interface Card). For example, the communication unit 210 performs wireless communication with the base station device 30 to be connected to a core network. The communication unit 210 receives the moving image data of the game from the information processing device 10 via the base station device 30. The communication unit 210 transmits a reception state of the moving image data and operation information of the game by the user to the information processing device 10 via the base station device 30.

(Decoding Unit 220)

The decoding unit 220 decodes the moving image data received by the communication unit 210. When failing in the decoding, the decoding unit 220 notifies the communication unit 210 to transmit reception error information indicating the failure in receiving the moving image data to the information processing device 10.

(Rendering Processing Unit 230)

The rendering processing unit 230 renders the moving image data decoded by the decoding unit 220 and causes the display device 300 to display a rendered moving image.

(Operation Acquiring Unit 240)

The operation acquiring unit 240 acquires operation of the operation device 400 by the user. The operation acquiring unit 240 outputs the acquired operation to the communication unit 210 as operation information.

(Display Device 300)

The display device 300 is a device that displays moving image data to the user such as a liquid crystal display or an organic EL display (Organic Electroluminescence Display). The display device 300 may be, for example, a head mounted display (HMD) worn on a head and used.

(Operation Device 400)

The operation device 400 is a controller that detects game operation by the user. The user operates the operation device 400 while viewing a game screen displayed on the display device 300 to operate the game.

[Information Processing Device 10]

As illustrated in FIG. 2, the information processing device 10 is, for example, a game server and transmits moving image data to be displayed as a game screen to the terminal device 20 via the base station device 30. Furthermore, the information processing device 10 receives, from the terminal device 20, a reception state of the moving image data and information (operation information) concerning operation performed by the user on the game screen from the terminal device 20.

The information processing device 10 includes an application unit 110, a rendering processing unit 120, an encoding unit 130, a communication unit 140, an acquiring unit 150, and a control unit 160.

(Application Unit 110)

The application unit 110 is one or two or more applications that provide a service to the terminal device 20 based on information acquired by the acquiring unit 150. The application unit 110 is realized by, for example, a program operating on a CPU (Central Processing Unit) and causes the terminal device 20 to display a moving image to provide a game service to the user who uses the terminal device 20.

More specifically, the application unit 110 controls an operation of a game. For example, the application unit 110 outputs scene information in the game to the rendering processing unit 120. At this time, the application unit 110 sometimes inserts a moving image (Movie Cut-in) according to an operation state of the game. The application unit 110 sets an upper limit value of resolution and an upper limit value of a frame rate according to the game or a scene of the game and outputs the upper limit values to the control unit 160. When switching the scene of the game, the application unit 110 outputs information (a scene change flag) indicating the scene switching to the control unit 160.

Note that the service provided by the application unit 110 is not limited to the game service. The application unit 110 may provide various services such as a movie viewing service.

(Rendering Processing Unit 120)

The rendering processing unit 120 is a drawing unit that performs rendering processing for a moving image to be displayed on the terminal device 20. The rendering processing unit 120 renders a scene image of the game at predetermined rendering resolution and a frame rate according to instructions from the application unit 110 and the control unit 160.

The rendering processing unit 120 is configured by a processor such as a GPU (Graphics Processing Unit). The processor operates according to a predetermined program, whereby moving image information can be generated. Note that, when the rendering processing unit 120 is configured by a plurality of GPUs, the rendering processing unit 120 divides information concerning image generation as appropriate and performs image processing in parallel with the plurality of GPUs.

(Encoding Unit 130)

The encoding unit 130 encodes the scene image generated by the rendering processing unit 120 to output a compressed bit stream to the communication unit 140. The encoding unit 130 encodes the scene image using intra prediction or inter prediction. In the following explanation, the scene image encoded using the intra prediction is described as intra image (intra picture) as well and the scene image encoded using the inter prediction is described as inter image (inter picture) as well. The encoding unit 130 generates an intra image or an inter image according to an instruction of the control unit 160.

(Communication Unit 140)

The communication unit 140 is a communication interface (I/F) that communicates with an external device. The communication unit 140 is realized by, for example, an NIC (Network Interface Card). For example, the communication unit 140 communicates with the core network to which the base station device 30 is connected. The communication unit 140 converts the scene image encoded by the encoding unit 130 into a transmission signal and transmits the transmission signal to the terminal device 20 via the core network and the base station device 30. The communication unit 140 receives information (reception error information) indicating that the failure in receiving the scene image from the terminal device 20 and notifies a reception result to the control unit 160. When reservation of a band is requested from the control unit 160, the communication unit 140 requests the core network to reserve the requested band. The communication unit 140 notifies the control unit 160 of information concerning a band secured by being approved from the core network as a result of the reservation. The communication unit 140 notifies the control unit 160 of information concerning a band (hereinafter referred to as a current transmission band as well) currently used for communication.

(Acquiring Unit 150)

The acquiring unit 150 acquires information concerning operation performed by the user on the game (hereinafter referred to as operation information as well) from the terminal device 20 via the communication unit 140. The acquiring unit 150 notifies the acquired operation information to the application unit 110. The application unit 110 generates a scene image and switches a scene based on the operation information. Note that the acquiring unit 150 may be omitted and the function of the acquiring unit 150 may be realized by the application unit 110.

(Control Unit 160)

The control unit 160 controls the units of the information processing device 10. The control unit 160 is realized by a program stored inside the information processing device 10 being executed by a CPU (Central Processing Unit), an MPU (Micro Processing Unit, or the like using a RAM (Random Access Memory) or the like as a work area. The control unit 160 is realized by, for example, an integrated circuit such as an ASIC (Application Specific Integrated Circuit) or an FPGA (Field Programmable Gate Array).

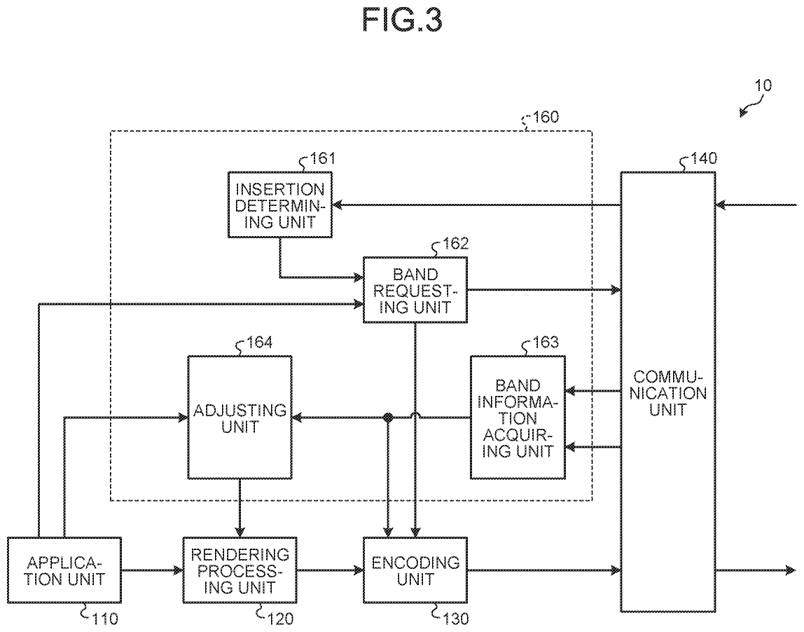

FIG. 3 is a diagram illustrating a configuration example of the control unit 160 according to the first embodiment of the present disclosure. As illustrated in FIG. 3, the control unit 160 includes an insertion determining unit 161, a band requesting unit 162, a band information acquiring unit 163, and an adjusting unit 164 and realizes or executes a function and action of information processing explained below. Note that an internal configuration of the control unit 160 is not limited to the configuration illustrated in FIG. 3 and may be another configuration if the control unit 160 is configured to perform information processing explained below. A connection relation among the processing units included in the control unit 160 is not limited to the connection relation illustrated in FIG. 3 and may be another connection relation.

(Insertion Determining Unit 161)

When acquiring reception error information from the terminal device 20 via the communication unit 140, the insertion determining unit 161 determines whether to insert retransmission of an intra image into image transmission for image reset in the terminal device 20. The information processing device 10 changes an encoding method of an unsuccessfully received image from an inter image to an intra image and retransmits the image, whereby the terminal device 20 can resume (reset) interrupted reproduction of the moving image.

Note that the insertion determining unit 161 does not always insert retransmission of the intra image even if the insertion determining unit 161 acquires the reception error information from the terminal device 20. For example, when the terminal device 20 fails in receiving a non-reference frame or the like, the insertion determining unit 161 determines not to retransmit the intra image.

The insertion determining unit 161 outputs a determination result to the band requesting unit 162.

(Band Requesting Unit 162)

The band requesting unit 162 requests reservation of a band to the communication unit 140 according to the determination result of the intra image retransmission acquired from the insertion determining unit 161 or the scene change flag acquired from the application unit 110.

When determining to retransmit the intra image, the insertion determining unit 161 requests the communication unit 140 to reserve a band. When the application unit 110 determines to switch the game scene and notifies the scene change flag including the determination result to the band requesting unit 162, the band requesting unit 162 requests the communication unit 140 to reserve a band.

As explained above, at the time of the retransmission of the intra image or the scene switching, ae bandwidth of the band requested by the band requesting unit 162 to be reserved is wider compared with a bandwidth at the time when an inter image is transmitted at time other than the scene switching time. In the following explanation, the bandwidth requested to be reserved at the time of the retransmission of the intra image or the scene switching is sometimes described as “wideband” or “band large”.

Note that, when reservation a wideband transmission band is requested, the band requesting unit 162 may request reservation of a band with a predetermined bandwidth or may request reservation with a bandwidth corresponding to an information amount of a scene image to be transmitted. For example, when the intra image is retransmitted, the band requesting unit 162 may request reservation according to the resolution of the intra image. Alternatively, in the case of the scene switching, the band requesting unit 162 may acquire information concerning an upper limit value of the resolution of a scene image after scene switching from the application unit 110 and request the communication unit 140 to reserve a band corresponding to such an upper limit value of the resolution.

Note that, in the following explanation, in order to simplify explanation, when the inter image is transmitted without switching the scene, the band requesting unit 162 does not request reservation of a band but is not limited this. For example, even when the inter image is transmitted without switching the scene, the band requesting unit 162 may request the communication unit 140 to reserve a band with a bandwidth corresponding to resolution and a frame rate of the inter image. In this case, the bandwidth of the band requested by the band requesting unit 162 is a narrower bandwidth (hereinafter described as “band small” as well) compared with a bandwidth (a wideband) requested to be reserved at the time of retransmission of the intra image or scene switching.

When receiving, from the insertion determining unit 161, a determination result that the intra image is retransmitted, the band requesting unit 162 instructs the encoding unit 130 to generate an intra image for retransmission. When receiving the instruction from the band requesting unit 162, the encoding unit 130 generates an intra image for retransmission.

When it is no longer necessary to secure the wideband transmission band, the band requesting unit 162 requests the communication unit 140 to release the securing of the wideband transmission band and open the transmission band the wideband. Details of timing when the band requesting unit 162 requests release of the securing of the wideband is explained below.

(Band Information Acquiring Unit 163)

The band information acquiring unit 163 acquires band information regarding a band from the communication unit 140. For example, as a result of the communication unit 140 reserving a wideband transmission band for the core network, the band information acquiring unit 163 acquires information concerning the secured transmission band (hereinafter described as secured band information as well). The band information acquiring unit 163 acquires information concerning a current transmission band from, for example, the communication unit 140.

The band information acquiring unit 163 predicts a bandwidth available for transmission of a scene image based on the acquired information. When the communication unit 140 secures a band, the band information acquiring unit 163 predicts a bandwidth of the secured band as an available bandwidth. Note that the transmission band of the bandwidth requested by the communication unit 140 is not always secured depending on a congestion state of the core network and the wireless network between the terminal device 20 and the base station device 30. When the core network and the wireless network are congested, only a transmission band having a bandwidth narrower than the reserved bandwidth is sometimes secured. In such a case, by predicting the bandwidth of the band secured by the band information acquiring unit 163 as the available bandwidth, the information processing device 10 can perform rendering processing and encoding processing corresponding to the secured band.

On the other hand, when the communication unit 140 fails in securing a band or does not secure a band, the band information acquiring unit 163 predicts a bandwidth of a current transmission band as the available bandwidth.

When the communication unit 140 releases the bandwidth securing, the band information acquiring unit 163 predicts, as the available bandwidth, for example, a bandwidth of a band used before the bandwidth is secured.

The band information acquiring unit 163 determines, based on the predicted available bandwidth, an encoding rate in the encoding unit 130 encoding a scene image and controls the encoding unit 130 to perform encoding at the determined encoding rate. Alternatively, the encoding unit 130 may control the encoding rate by notifying the encoding unit 130 of information concerning the available bandwidth predicted by the band information acquiring unit 163.

The band information acquiring unit 163 notifies the adjusting unit 164 of information concerning the predicted available bandwidth.

(Adjusting Unit 164)

The adjusting unit 164 adjusts the resolution and the frame rate of the rendering of the scene image by the rendering processing unit 120. In addition to the upper limit value of the resolution and the upper limit value of the frame rate acquired from the application unit 110, the adjusting unit 164 determines resolution and a frame rate of the rendering by the rendering processing unit 120 according to the available bandwidth acquired from the band information acquiring unit 163. The adjusting unit 164 notifies the determined resolution and the determined frame rate to the rendering processing unit 120.

The adjusting unit 164 may change, according to a type of a service provided by the application unit 110, which of the resolution and the frame rate is preferentially adjusted. For example, in the case of a game with fast motion such as a sports game or an FPS (First Person Shooter), the adjusting unit 164 preferentially adjusts the resolution so that a high frame rate state can be maintained. On the other hand, in a game with slow motion such as a role playing game or a simulation game, the adjusting unit 164 preferentially adjusts the frame rate so that a high resolution state can be maintained.

<2.2. Operation Example of the Information Processing Device>

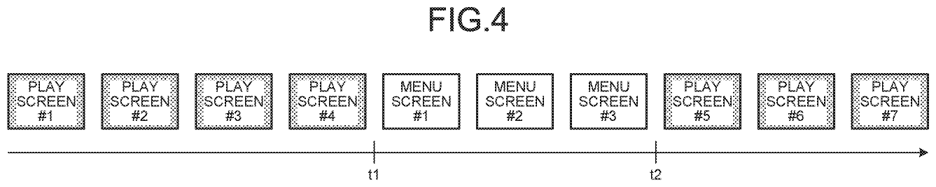

Subsequently, an operation of the information processing device 10 is explained. FIG. 4 is a diagram for explaining an operation of the information processing device 10 according to the first embodiment of the present disclosure. As illustrated in FIG. 4, it is assumed that the application unit 110 causes the display device 300 to display play screens #1 to #4, menu screens #1 to #3, and play screens #5 to #7 in this order. Note that the screens illustrated in FIG. 4 are examples. Screens displayed by the application unit 110 are not limited to the play screens and the menu screens. Display times of the screens can be changed as appropriate.

As illustrated in FIG. 4, when the information processing device 10 transmits a play screen and a menu screen to the terminal device 20 as a scene image, the scene image is switched from the play screen #4 to the menu screen #1 at time t1 and the scene image is switched from the menu screen #3 to the play screen #5 at time t2. In this way, when the scene switching occurs, difference information of the scene image before and after the switching increases and an amount of information transmitted by the information processing device 10 increases. When the scene switching occurs and the amount of information to be transmitted increases in this way, the band requesting unit 162 of the information processing device 10 determines to secure a wider band and transmit a scene image and requests the communication unit 140 to reserve a wideband transmission band.

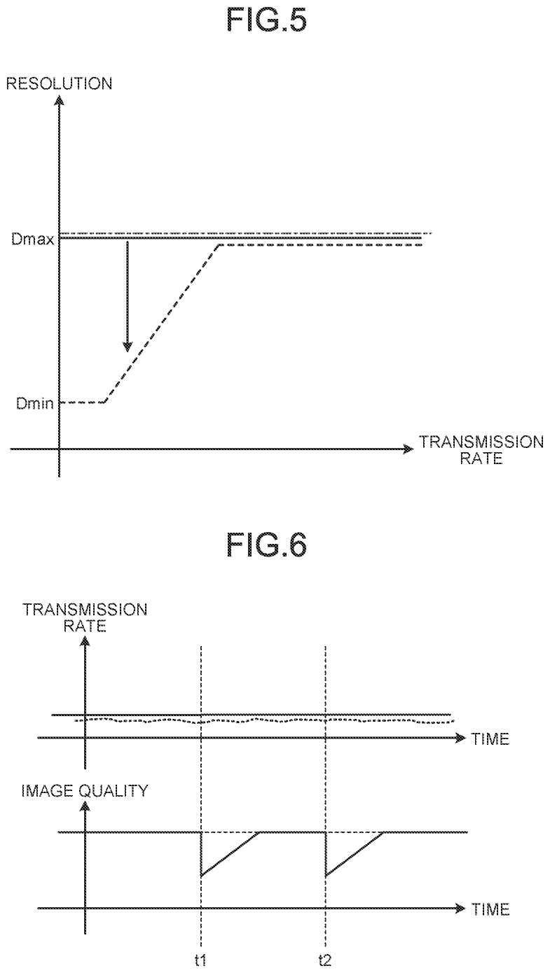

A case where the band requesting unit 162 does not request reservation of a wideband transmission band and the communication unit 140 transmits a scene image to the terminal device 20 at a constant transmission rate (bandwidth) is explained with reference to FIG. 5 and FIG. 6. FIG. 5 and FIG. 6 are diagrams for explaining a transmission method in a case where a transmission rate is constant. Note that it is assumed that resolution is not adjusted by the adjusting unit 164.

In this case, since the adjusting unit 164 does not adjust resolution, the rendering processing unit 120 renders a scene image with an upper limit value of rendering resolution determined by the application unit 110. However, since the communication unit 140 transmits the scene image at a constant transmission rate, if the scene image with high resolution is transmitted as it is, a transmission delay increases and a frame rate decreases.

Therefore, as illustrated in FIG. 5, the information processing device 10 does not transmit the scene image rendered by the rendering processing unit 120 as it is but performs down-sampling processing for reducing the resolution with a down-sampling filter or the like according to the transmission rate and then transmits the scene image from the communication unit 140. Such down-sampling processing can be performed by, for example, the communication unit 140.

Note that, in FIG. 5, the upper limit value of the rendering resolution determined by the application unit 110 is indicated by an alternate long and short dash line, the resolution of the scene image output from the rendering processing unit 120 is indicated by a solid line, and the resolution of the scene image transmitted by the communication unit 140 is indicated by a dotted line. In FIG. 5, in order to make the figure to be seen clearly, the lines are shifted not to overlap. However, the lines may overlap.

In this way, for example, when the amount of information to be transmitted increases and the transmission rate decreases, the information processing device 10 performs down-sampling processing in order to keep the transmission rate constant. Therefore, when the scene switching occurs at the times t1 and t2 (see FIG. 4) and the amount of information transmitted to the terminal device 20 increases, the information processing device 10 executes the down-sampling processing for the scene image at the times t1 and t2. Consequently, the transmission rate of the transmission to the terminal device 20 becomes constant but the image quality of the scene image is deteriorated at the times t1 and t2 as illustrated in FIG. 6.

Note that, in FIG. 6, a transmission rate using an available transmission band is indicated by a solid line and a transmission rate at the time when the communication unit 140 actually transmits the scene image is indicated by a dotted line.

On the other hand, in the information processing device 10 according to the present embodiment, as explained above, the band requesting unit 162 requests the communication unit 140 to reserve a band at the timing when the amount of information to be transmitted increases (the scene switching). The adjusting unit 164 adjusts the resolution and the frame rate of the rendering according to the transmission rate of the scene image transmitted by the communication unit 140.

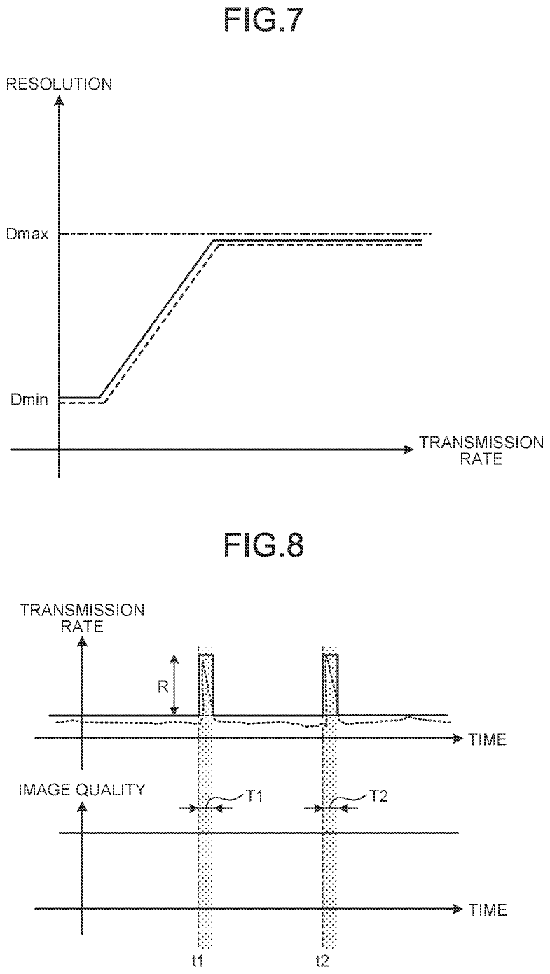

First, the adjustment of the resolution of the rendering by the adjusting unit 164 is explained with reference to FIG. 7. On order to simplify explanation, a case where the adjusting unit 164 adjusts the resolution is explained. FIG. 7 is a diagram for explaining the adjusting unit 164 according to the first embodiment of the present disclosure.

As illustrated in FIG. 7, the adjusting unit 164 adjusts rendering resolution of the rendering processing unit 120 according to a transmission rate. More specifically, the adjusting unit 164 adjusts the rendering resolution of the rendering processing unit 120 to perform rendering at resolution of a scene image that the communication unit 140 can transmit according to a transmission rate. As the transmission rate is higher, the rendering resolution is larger and, as the transmission rate is lower, the rendering resolution is smaller. Note that, when the rendering resolution reaches an upper limit value or a lower limit value, the adjusting unit 164 may fix the resolution and adjust the frame rate.

Consequently, the down-sampling processing by the information processing device 10 can be omitted and a component necessary for the down-sampling processing such as a down-sampling filter can be omitted.

Note that, in FIG. 7, an upper limit value of rendering resolution determined by the application unit 110 is indicated by an alternate long and short dash line, resolution of a scene image output from the rendering processing unit 120 is indicated by a solid line, and resolution of a scene image that can be transmitted by the communication unit 140 is indicated by a dotted line. In FIG. 7, in order to make the figure to be seen clearly, the lines are shifted not to overlap. However, but the lines may overlap.

Subsequently, a case where band reservation by the band requesting unit 162 is requested is explained with reference to FIG. 8. FIG. 8 is a diagram for explaining the band requesting unit 162 according to the first embodiment of the present disclosure.

When scene switching occurs at the times t1 and t2 (see FIG. 4), the band requesting unit 162 requests the communication unit 140 to reserve a band. When the communication unit 140 receives the request and secures a wide bandwidth, as illustrated in FIG. 8, the transmission rate increases at the times t1 and t2 when scene switching occurs and a decrease in resolution (image quality) can be suppressed.

When a predetermined period (In FIG. 7, periods T1 and T2) elapses from the times t1 and t2 and the scene switching of the application unit 110 ends, the band requesting unit 162 requests the communication unit 140 to open the secured band (securing release). Consequently, the transmission rate returns from a high transmission rate state (wideband) to the transmission rate before the scene switching (normal). When the scene switching ends, the amount of information transmitted by the communication unit 140 returns to the amount of information before the switching. Therefore, the information processing device 10 can transmit the scene image without deteriorating the image quality even if the transmission rate returns to the transmission rate before the scene switching. By returning the transmission rate from the high state to the normal low state, unnecessary occupation of a band can be suppressed and an increase in communication cost can be suppressed.

Note that, in FIG. 8, a transmission rate corresponding to an available transmission band is indicated by a solid line and a transmission rate of a scene image actually transmitted by the communication unit 140 is indicated by a dotted line.

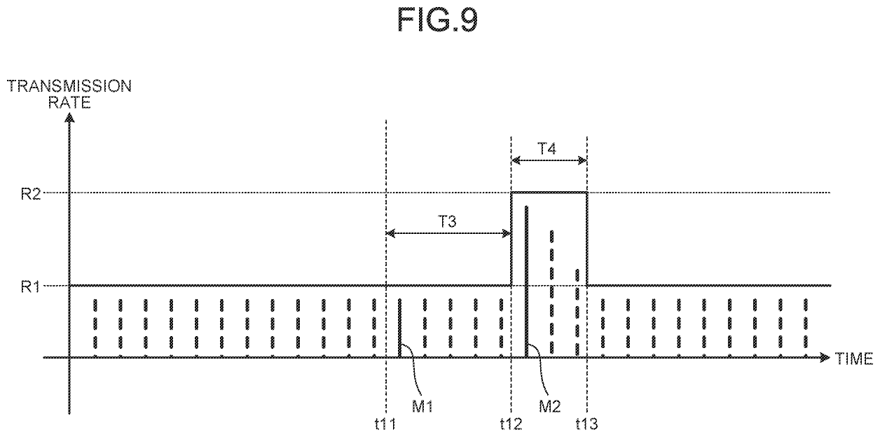

In the example explained above, the case where the band requesting unit 162 requests the reservation of the wideband transmission band at the time of scene switching is explained. However, the band requesting unit 162 requests reservation of a wideband in order to insert, for example, an intra image when receiving reception error information. A case where the band requesting unit 162 requests reservation of a wideband in order to insert an intra image is explained with reference to FIG. 9. FIG. 9 is a diagram for explaining another example of the operation of the information processing device 10 according to the first embodiment of the present disclosure.

In FIG. 9, the information processing device 10 transmits scene images at predetermined intervals according to a frame rate. A thick dotted line in FIG. 9 indicates a case where an inter image is transmitted and a thick solid line indicates a case where an intra image is transmitted. A thin dotted line indicates a transmission rate at the time when the communication unit 140 uses a bandwidth available for communication. Note that a transmission rate R1 is a transmission rate (described as normal transmission rate as well) available when a wideband transmission band is not secured and a transmission rate R2 is a transmission rate available when a wideband transmission band is secured.

As illustrated in FIG. 9, the information processing device 10 transmits scene images, which are inter images, at predetermined intervals up to time t11 with the transmission rate R1 set as an upper limit. It is assumed that the insertion determining unit 161 determines to insert an intra image at the time t1 and the band requesting unit 162 requests the communication unit 140 to reserve a band.

In this case, the encoding unit 130 generates an intra image instead of an inter image generated to that point. However, in some case, a deviation of a predetermined period (a period T3 in FIG. 9) occurs from when the band requesting unit 162 requests the band reservation until when the communication unit 140 actually secures a band. In such a case, if the communication unit 140 waits until a band is secured and transmits the intra image, it is likely that recovery from the image reception error in the terminal device 20 takes time.

Therefore, in the present embodiment, when the insertion determining unit 161 determines to insert an intra image, the information processing device 10 transmits an intra image M1 at the next timing of the time t1 without waiting until the communication unit 140 secures a wideband transmission band. In this case, the information processing device 10 transmits a scene image at a normal transmission rate R1 until time t12 when the communication unit 140 secures a wideband transmission band. For example, the adjusting unit 164 adjusts the resolution of rendering such that the scene image is transmitted at the transmission rate R1. Consequently, image quality is deteriorated until time t12 when the communication unit 140 secures the wideband transmission band. However, the terminal device 20 can recover from the image reception error without waiting until the wideband transmission band is secured.

The information processing device 10 inserts an intra image at the next timing next of the time t12 when the communication unit 140 secures the wideband transmission band. At this time, the adjusting unit 164 inserts an intra image M2 having resolution higher than that of the intra image M1 according to the transmission rate R2 in the wideband transmission band secured by the communication unit 140. Consequently, the terminal device 20 can recover from a low-resolution image and the period of image quality deterioration can be reduced.

Note that the band requesting unit 162 requests the communication unit 140 to release the securing of the wideband transmission band at time t13 after elapse of a predetermined period from the insertion of the intra image M2. Thereafter, the information processing device 10 transmits an inter image at the normal transmission rate R1.

Note that, when the period T3 from the request for the band reservation to the band securing is shorter than a certain period, for example, equal to or less than a frame rate, the information processing device 10 may omit the insertion of the intra image M1 and may wait for band securing and insert the intra image M2.

Note that the information processing device 10 inserts the intra image at the reception error information reception time but is not limited this. For example, when the encoding rate is sufficiently high, the information processing device 10 may insert an inter image instead of the intra image.

Although the case where the intra image is inserted is explained, it is likely that a deviation also occurs from the request to the band securing when the band requesting unit 162 requests band reservation in scene switching. In this case, the information processing device 10 may also transmit the scene image without waiting for the band securing. Alternatively, for example, in scene switching in which a slight delay is allowed such as switching from a play screen to a menu screen, the information processing device 10 may wait for the band securing and switch the scene.

<2.3. Moving Image Transmission Processing>

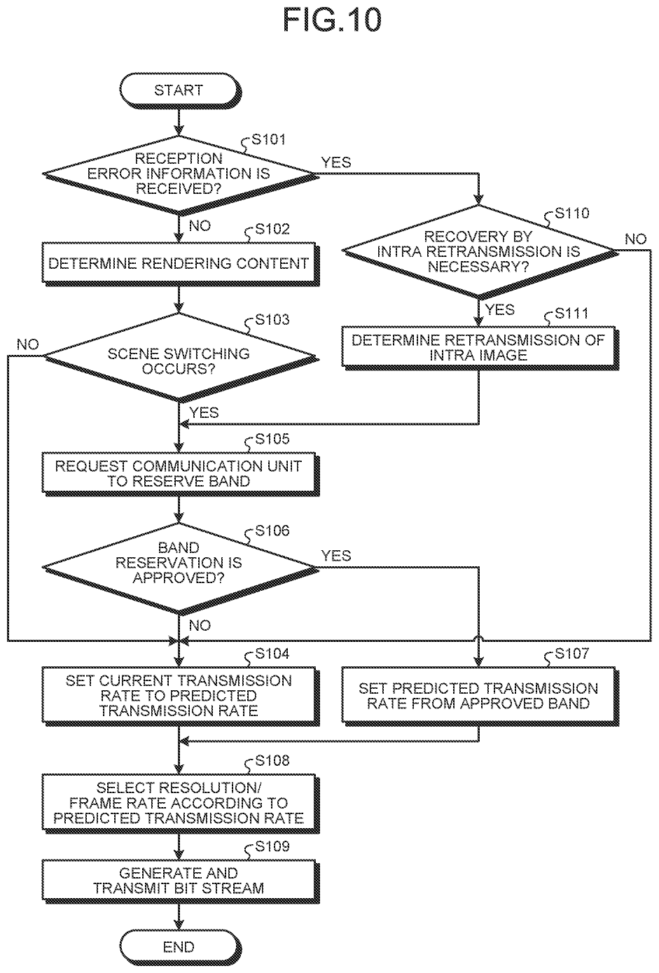

Subsequently, moving image transmission processing according to the first embodiment of the present disclosure is explained with reference to FIG. 10. FIG. 10 is a flowchart illustrating a moving image transmission processing procedure according to the first embodiment of the present disclosure.

As illustrated in FIG. 10, the information processing device 10 determines whether reception error information is received from the terminal device 20 (step S101). When reception error information is not received (step S101; No), the application unit 110 of the information processing device 10 determines content of a scene image transmitted to the terminal device 20, that is, rendering content (step S102).

Subsequently, the information processing device 10 determines whether scene switching occurs because of the rendering determined by the application unit 110 (step S103). When scene switching does not occur (step S103; No), the information processing device 10 sets a current transmission rate (a transmission rate in a current transmission band) to a predicted transmission rate (equivalent to a transmission rate in the predicted available bandwidth explained above) (step S104).

On the other hand, when scene switching occurs (step S103; Yes), the information processing device 10 requests the communication unit 140 to reserve a wideband transmission band (step S105). After requesting the band reservation is requested, the information processing device 10 determines whether the band reservation is approved by the core network (step S106). When the bandwidth reservation is not approved (step S106; No), the information processing device 10 proceeds to step S104. On the other hand, when the band reservation is approved and the wideband transmission band is secured (step S106; Yes), the information processing device 10 sets the predicted transmission rate (equivalent to the transmission rate in the predicted available bandwidth explained above) from the approved band (step S107). Note that, depending on a congestion state of the core network, the approved band is sometimes narrower than a band for which reservation is requested. Therefore, the information processing device 10 sets the predicted transmission rate not from the reserved band but from an actually approved band.

Subsequently, the information processing device 10 selects resolution and a frame rate of the rendering processing unit 120 according to the set predicted transmission rate (step S108). The information processing device 10 encodes, with the encoding unit 130, a scene image rendered at the selected resolution and the selected frame rate, generates a bit stream, and transmits the generated bit stream (step S109).

Returning to step S101, when the information processing device 10 receives reception error information as a result of determining whether the reception error information is received (step S101; Yes), the information processing device 10 determines whether image restoration (recovery) by retransmission of an intra image is necessary (step S110).

When determining that the recovery is necessary (step S110; Yes), the information processing device 10 determines retransmission of the intra image by the encoding unit 130 (step S111), and proceeds to step S105. On the other hand, when determining that the recovery is unnecessary (step S110; No), the information processing device 10 proceeds to step S104.

As explained above, according to the first embodiment of the present disclosure, the information processing device 10 includes the band requesting unit 162, the adjusting unit 164, and the communication unit 140 (an example of a transmitting unit). The band requesting unit 162 requests, according to a bandwidth necessary for transmission of a scene image (an example of information including a moving image), use reservation of the bandwidth. The adjusting unit 164 adjusts, according to a result of the request by the band requesting unit 162 and a reserved bandwidth, resolution or a frame rate (an example of an amount of information) of the scene image to be transmitted. The communication unit 140 converts the scene image, the resolution or the frame rate of which is adjusted, into a transmission signal and transmits the transmission signal.

Consequently, the information processing device 10 can suppress delay in image transmission, deterioration in image quality, or the like, and can suppress deterioration in usability.

### 3. First Modification

In the first embodiment explained above, the band requesting unit 162 requests the reservation of the wideband transmission band at the time of the scene switching or the intra image insertion. However, a condition for the band requesting unit 162 to request the reservation of the wideband transmission band is not limited to this. For example, the band requesting unit 162 may request the reservation of the wideband transmission band according to an amount of data required by the terminal device 20 (the user). Therefore, in the first modification, an example is explained in which the band requesting unit 162 requests reservation of a wideband transmission band according to the amount of data required by the terminal device 20 (the user) (an amount of information requested by the user).

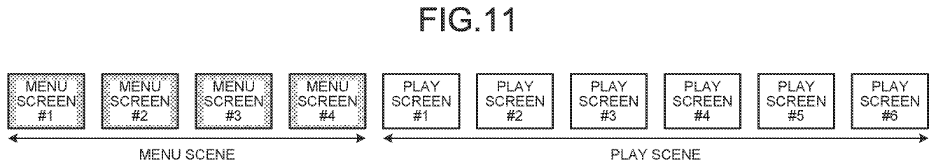

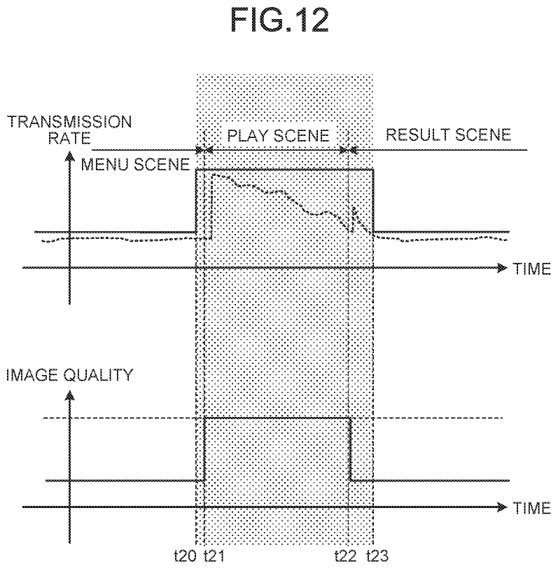

FIG. 11 and FIG. 12 are diagrams for explaining a band reservation request by the band requesting unit 162 according to the first modification of the present disclosure.

As illustrated in FIG. 11, for example, it is assumed that the information processing device 10 transmits menu screens #1 to #4 as menu scenes first and subsequently transmits play screens #1 to #6 as play scenes. At this time, in general, a game includes, in addition to play scenes in which the user actually plays the game, a large number of menu scenes such as a play start time, characters to be used, and stage setting. Compared with the play scenes, the menu scenes have less movement. Deterioration in image quality and a delay are more easily allowed.

Therefore, the band requesting unit 162 requests the communication unit 140 to reserve a band so as to secure a wideband transmission band at the time of play screen transmission in a play scene in which high resolution and a high frame rate are requested. At the time of menu screen transmission in a menu scene that is allowed even at low resolution and a low frame rate, the band requesting unit 162 releases the secured wideband transmission band and performs transmission in a normal transmission band.

The application unit 110 switches a scene according to, for example, operation information from the terminal device 20. In other words, the application unit 110 performs scene switching in response to a request from the terminal device 20. From this, it can also be said that the band requesting unit 162 requests reservation of a wideband transmission band in response to a request from the terminal device 20.

In the example of FIG. 12, the information processing device 10 transmits a scene image of a menu scene at a low transmission rate until time t20. The band requesting unit 162 requests reservation of a wideband transmission band and transmits a scene image at a high transmission rate after the time t20 when the wideband transmission band is secured. Note that, in FIG. 12, a transmission rate available to the information processing device 10 is indicated by a solid line and a transmission rate at which the information processing device 10 actually transmits the scene image is indicated by a dotted line.

In the example illustrated in FIG. 12, the information processing device 10 transmits the scene image at a high transmission rate from the time t20 earlier than time t21 when a play scene starts. In other words, the band requesting unit 162 requests reservation of a transmission band so that the wideband transmission band can be used from the time t20 earlier than the time t21 when a scene is switched. Consequently, a high transmission rate can be used at the time t21 earlier than scene switching time and a wideband transmission band can be secured. Therefore, the information processing device 10 can smoothly switch the scene to a play scene in which high resolution and a high frame rate are required.

For example, when a result scene for displaying a play result follows the play scene, the information processing device 10 releases a wideband transmission band secured at time t23 after the play scene is switched to the result scene. Consequently, the available transmission rate is switched from a high transmission rate to a low transmission rate. The information processing device 10 transmits a scene image at the high transmission rate until the time t23 and transmits the scene image at the low transmission rate after the time t23.

As explained in the first embodiment, in the transmission of the scene image, an amount of information increases at the time of scene switching. Therefore, the band requesting unit 162 releases the transmission band secured at the time t23 after the scene is switched. Consequently, the information processing device 10 can suppress deterioration in image quality even when the amount of information increases at the time of scene switching.

In this way, the information processing device 10 can transmit a high-quality scene image in a play scene having a large required data amount as illustrated in FIG. 12 by requesting the reservation of the wideband transmission band according to the play scene.

Note that the band requesting unit 162 acquires, from the application unit 110, in addition to the information concerning the scene switching (scene change flag), scene information concerning an amount of information (or a transmission rate) requested after the scene switching. The band requesting unit 162 requests reservation of a wideband transmission band based on the acquired scene information.

Note that the scenes and display times of the scenes illustrated in FIG. 11 and FIG. 12 are examples and can be changed as appropriate.

As explained above, the information processing device 10 performs a reservation request for a wideband transmission band according to an amount of data required by the user, in other words, a game scene to be transmitted. Consequently, it is possible to transmit data (a scene image) of a data amount (an information amount) required by the user while reducing image quality deterioration, a delay, and the like. It is possible to suppress deterioration of usability.

### 4. Second Modification

Subsequently, a second modification according to the first embodiment is explained. The band requesting unit 162 requests or releases a reservation of a wideband transmission band based on a response of the user to a game, in other words, an operation state by the user.

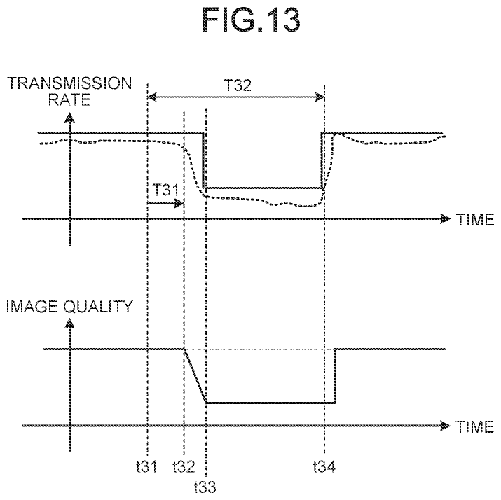

FIG. 13 is a diagram for explaining the band requesting unit 162 according to the second modification of the present disclosure. In an upper diagram of FIG. 13, a transmission rate available by the information processing device 10 is indicated by a solid line and a transmission rate of a scene image transmitted by the information processing device 10 is indicated by a dotted line.

As illustrated in FIG. 13, it is assumed that, in a state in which an available transmission rate (transmission band) of the information processing device 10 is high, there is no response from the user from time t31 and the information processing device 10 is in a non-operation state.

In this case, the information processing device 10 adjusts resolution and a frame rate so that a transmission rate decreases at time t32 when a certain period T31 elapses from time t31 when the information processing device 10 is in a non-operation state. When the non-operation state of the user continues even after the time t32 and the transmission rate is sufficiently lowered by the information processing device 10, the band requesting unit 162 requests the communication unit 140 to release the securing of the wideband transmission band. Consequently, the band secured at time t33 is opened.

The transmission rate being sufficiently lowered means that the transmission rate is lowered to a transmission rate at which the scene image can be transmitted even if the secured band is opened. The band requesting unit 162 can determine, based on for example, the transmission rate available before the band is secured, whether the transmission rate is sufficiently lowered.

When the user makes some response to the game at time t34 to release the non-operation state, the band requesting unit 162 requests the communication unit 140 to reserve a wideband transmission band. Consequently, a wideband transmission band is secured again at time t32 and the transmission rate increases. When the high transmission rate becomes available, the information processing device 10 returns the resolution and the frame rate to those before the non-operation state of the user and returns the image quality to high image quality.

In this way, the information processing device 10 requests the reservation of the wideband transmission band according to the response of the user. Therefore, so that the broadband transmission band secured in the case of the user's non-operation state can be released. Consequently, a wideband transmission band can be prevented from being secured in a period in which there is no problem even if image quality is lowered. An increase in communication cost can be suppressed.

### 5. Second Embodiment

<5.1. Remote Control System>

In the first embodiment explained above, a case where the technique of the present disclosure is applied to the system that provides the game service to the user is explained. Besides the example explained above, the technique of the present disclosure may be applied to, for example, a remote control system. Therefore, in a second embodiment, a case where the technique of the present disclosure is applied to a remote control system of an automobile as a remote control system is explained. Note that a remote control target is explained as an automobile. However, the remote control target is not limited to the automobile and can be applied to remote control of various mobile bodies such as personal mobility, an airplane, a drone, a ship, and a robot.

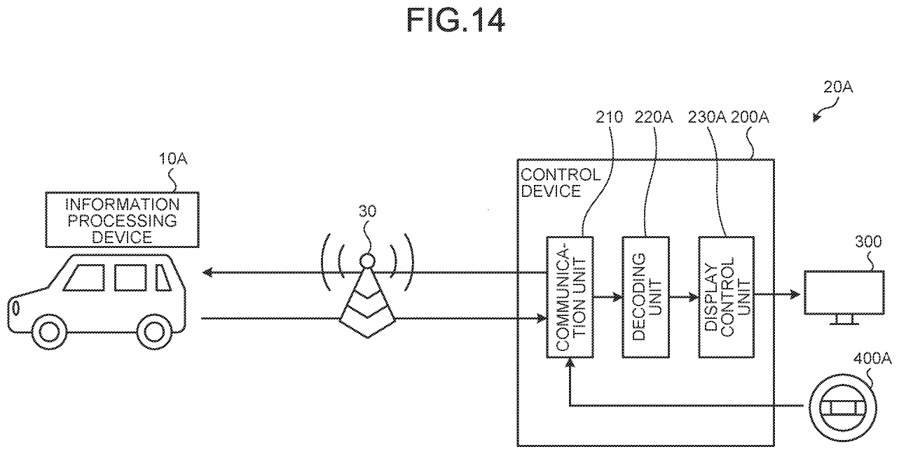

FIG. 14 is a diagram illustrating a configuration example of a remote control system according to the second embodiment of the present disclosure. As illustrated in FIG. 14, the remote control system includes an information processing device 10A, a terminal device 20A, and the base station device 30.

The information processing device 10A is mounted on, for example, an automobile (hereinafter described as own vehicle as well) and controls traveling of the automobile. The information processing device 10A transmits information used for traveling control of the automobile (hereinafter described as traveling information as well) via the base station device 30. The traveling information includes, for example, information of a sensing result (hereinafter described as sensor information as well) acquired by a sensor mounted on an automobile. More specifically, the traveling information includes, for example, a captured image by a vehicle-mounted camera, speed of the automobile, position information of the automobile, and depth information by a distance measuring device such as a Lider or a Radar mounted on the automobile.

The information processing device 10A receives operation information for operating the automobile from the terminal device 20A. The information processing device 10A controls traveling of the automobile by operating the automobile based on the received operation information.

The terminal device 20A presents the traveling information acquired from the information processing device 10A to the user and acquires, as the operation information, operation performed by the user to cause the automobile to travel.

The terminal device 20A includes a control device 200A, the display device 300, and an operation device 400A. The operation device 400A may be an operation device imitating operation means of the automobile such as a steering wheel, a brake pedal, or an accelerator pedal or may be input means that can be used for operation other than the operation of the automobile such as a keyboard, a mouse, or a game controller.

The control device 200A includes the communication unit 210, a decoding unit 220A, and a display control unit 230A. Note that, although the operation acquiring unit 240 illustrated in FIG. 2 is omitted in FIG. 14, the control device 200A may include the operation acquiring unit 240 to acquire operation of the operation device 400A as in FIG. 2.

The decoding unit 220A decodes traveling information received from the information processing device 10A and outputs the decoded traveling information to the display control unit 230A.

The display control unit 230A displays the traveling information decoded by the decoding unit 220A on the display device 300 with a display method corresponding to each piece of information. For example, the display control unit 230A displays a captured image of the vehicle-mounted camera on the display device 300.

Alternatively, the display control unit 230A may detect an obstacle present around the automobile from the captured image and depth information detected by a distance measuring device and display a detection result on the display device 300 to be superimposed on the captured image. The obstacle includes, for example, a moving object such as another vehicle or a pedestrian and a stationary object such as a sign or a vehicle stop.

The display control unit 230A may display a map including the position of the automobile from position information of the automobile or may display navigation information including destination information of the automobile together with the map.

As explained above, the display control unit 230A causes, based on the traveling information, the display device 300 to display information used by the user to cause the automobile to travel.

Note that the display control unit 230A of the control device 200A causes the display device 300 to display various kinds of information but is not limited this. The information may be presented to the user by a method other than causing the display device 300 to display the information such as voice.

<5.2. Information Processing Device>

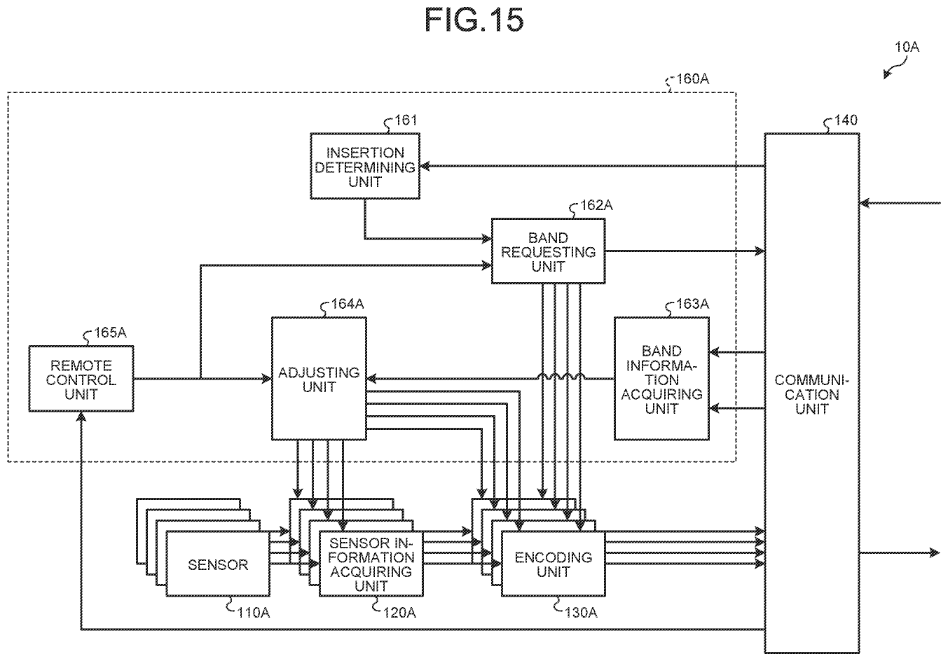

FIG. 15 is a block diagram illustrating a configuration example of the information processing device 10A according to the second embodiment of the present disclosure.

As illustrated in FIG. 15, the information processing device 10A includes a sensor 110A, a sensor information acquiring unit 120A, an encoding unit 130A, the communication unit 140, and a control unit 160A. In FIG. 15, the acquiring unit 150 illustrated in FIG. 2 is omitted.

(Sensor 110A)

The sensor 110A is information acquiring means for acquiring traveling information used for remote control of the automobile on which the information processing device 10A is mounted. A plurality of sensors 110A can be mounted on the automobile as illustrated in FIG. 14. The sensor 110A is, for example, the vehicle-mounted camera explained above, a speed sensor, or a distance measuring device such as a GPS (Global Positioning System), a Lider, or a Radar.

Note that these sensors 110A are examples. Sensors mounted on the automobile are not limited to those explained above. The sensor 110A can be various sensors such as an acceleration sensor.

(Sensor Information Acquiring Unit 120A)

The sensor information acquiring unit 120A acquires each piece of information detected by the sensor 110A. The sensor information acquiring unit 120A may be provided for each sensor 110A as illustrated in FIG. 15 or one sensor information acquiring unit 120A may acquire information of the plurality of sensors 110A.

The sensor information acquiring unit 120A acquires information of a predetermined sensor 110A according to an instruction from the control unit 160A and does not acquire information of the sensor 110A other than a predetermined sensor 110A. Alternatively, for example, when the sensor 110A is a vehicle-mounted camera, the sensor information acquiring unit 120A acquires a captured image at resolution and a frame rate designated by the control unit 160A. For example, when the sensor 110A is a distance measuring device, the sensor information acquiring unit 120A sub-samples, according to an instruction of the control unit 160A, depth information acquired from the sensor 110A and outputs the depth information to the encoding unit 130A.

(Encoding Unit 130A)

The encoding unit 130A encodes the information acquired by the sensor information acquiring unit 120A to generate a compressed bit stream. The encoding unit 130A generates an intra image or an inter image according to an instruction from the control unit 160A. For example, when the sensor 110A is a vehicle-mounted camera and the sensor information acquiring unit 120A acquires a captured image, the encoding unit 130A compresses the captured image by performing encoding. The encoding unit 130A encodes the captured image using intra prediction or inter prediction. The encoding unit 130A controls an encoding rate so that transmission can be performed at a designated transmission rate. When the sensor 110A is a distance measuring device and the sensor information acquiring unit 120A generates a depth image as depth information, the encoding unit 130A can compress the depth image by performing encoding in the same manner as for the captured image.

As illustrated in FIG. 15, the encoding unit 130A is provided for each sensor information acquiring unit 120A and performs encoding processing corresponding to the sensors 110A. Alternatively, one encoding unit 130A may perform encoding processing corresponding to the plurality of sensors 110A.

(Control Unit 160A)

The control unit 160A controls the units of the information processing device 10A. The control unit 160A is realized by a program stored inside the information processing device 10A being executed by a CPU (Central Processing Unit), an MPU (Micro Processing Unit), or the like using a RAM (Random Access Memory) or the like as a work area. The control unit 160A is realized by an integrated circuit such as an ASIC (Application Specific Integrated Circuit) or an FPGA (Field Programmable Gate Array).

As illustrated in FIG. 15, the control unit 160A includes an insertion determining unit 161A, a band requesting unit 162A, a band information acquiring unit 163A, an adjusting unit 164A, and a remote control unit 165A and realizes or executes a function and action of information processing explained below. Note that an internal configuration of the control unit 160A is not limited to the configuration illustrated in FIG. 15 and may be another configuration if the control unit 160A is configured to perform the information processing explained below. A connection relation among the processing units included in the control unit 160A is not limited to the connection relation illustrated in FIG. 15 and may be another connection relation.

(Remote Control Unit 165A)

The remote control unit 165A controls remote equipment (in the present embodiment, an automobile) based on operation information acquired from the terminal device 20A via the communication unit 140. A current operation state of the automobile is output to the band requesting unit 162A and the adjusting unit 164A.

(Insertion Determining Unit 161A)

When acquiring reception error information for traveling information from the terminal device 20A, the insertion determining unit 161A determines whether to insert such traveling information into the transmission of the traveling information in order to retransmit the unsuccessfully received traveling information. For example, when the traveling information is a captured image of the vehicle-mounted camera, the insertion determining unit 161A determines whether to insert retransmission of an intra image into image transmission when receiving, from the terminal device 20, the reception error information indicating that the terminal device 20 has failed in receiving the captured image.

The insertion determining unit 161A determines whether to insert retransmission of the information according to the information that the terminal device 20A has failed to receive.

(Band Requesting Unit 162A)

The band requesting unit 162A requests the communication unit 140 to reserve a wideband transmission band according to a retransmission determination result acquired from the insertion determining unit 161A or a current operation state of the automobile acquired from the remote control unit 165A. When determining to retransmit the traveling information, the insertion determining unit 161A requests the communication unit 140 to reserve a band necessary for retransmitting the traveling information. When the automobile is traveling, the band requesting unit 162A requests the communication unit 140 to reserve a predetermined band.

The band requesting unit 162A controls the encoding unit 130A to retransmit the traveling information determined by the insertion determining unit 161A to insert retransmission. For example, when the unsuccessfully received traveling information is a captured image of the vehicle-mounted camera, the band requesting unit 162A instructs the encoding unit 130A to generate an intra image for retransmission. When receiving the instruction from the band requesting unit 162A, the encoding unit 130A generates an intra image for retransmission.

When it is no longer necessary to secure a band, the band requesting unit 162A requests the communication unit 140 to release the securing of the band.

(Band Information Acquiring Unit 163A)

The band information acquiring unit 163A acquires band information concerning a band from the communication unit 140. The band information acquiring unit 163A acquires information concerning a band secured, for example, as a result of the communication unit 140 performing wideband transmission band reservation on the core network. The band information acquiring unit 163A acquires, for example, information concerning the current transmission band from the communication unit 140.

The band information acquiring unit 163A predicts a bandwidth available for transmission of traveling information based on the acquired information. When the communication unit 140 secures a band, the band information acquiring unit 163A predicts a bandwidth of the secured band as an available bandwidth. When the communication unit 140 fails in securing a band or does not secure a band, the band information acquiring unit 163A predicts a bandwidth of the current transmission band as the available bandwidth. When the communication unit 140 releases the bandwidth reservation, the band information acquiring unit 163A predicts, for example, a bandwidth of a band used before the securing of the band as the available bandwidth.

The band information acquiring unit 163A notifies the adjusting unit 164A of information concerning the predicted available bandwidth.

(Adjusting Unit 164A)

The adjusting unit 164A selects, according to the operation state acquired from the remote control unit 165A, information acquired and information stopped to be acquired by the sensor information acquiring unit 120A.

Alternatively, the adjusting unit 164A performs, according to the operation state, adjustment of resolution and a frame rate of a captured image, determination of presence or absence of sub-sampling of information, and the like.

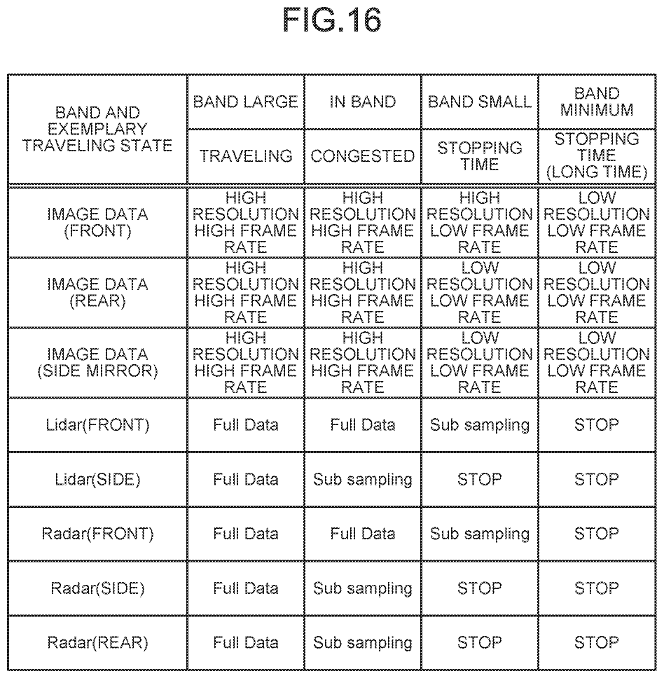

FIG. 16 is a diagram for explaining an example of information to be adjusted by the adjusting unit 164A according to the second embodiment of the present disclosure.

As illustrated in FIG. 16, the adjusting unit 164A adjusts, according to a traveling state (an operation state) of the automobile, information to be acquired. In FIG. 16, an example of a band for which the band requesting unit 162A explained above requests reservation is also illustrated. In FIG. 16, it is assumed that the sensors 110A are vehicle-mounted cameras respectively mounted in four places including the front, the rear, and side mirrors of the automobile, Lidars respectively mounted in three places including the front and the sides of the automobile, and Radars respectively mounted in four places including the front, the rear, and the sides of the automobile. Note that the number and disposition of the vehicle-mounted cameras, the Lidar, and the Radar mounted on the automobile are not limited this and can be changed as appropriate.

As illustrated in FIG. 16, when the traveling state of the automobile is “traveling”, the band requesting unit 162A reserves a transmission band with the widest band (“large band”) for the communication unit 140. When the transmission band of “band large” is secured, the adjusting unit 164A controls the sensor information acquiring unit 120A to acquire detection results from all of the sensors 110A of the vehicle-mounted cameras, the Lidars, and the Radars.

The adjusting unit 164A controls the sensor information acquiring unit 120A to acquire a captured image (image data) from the vehicle-mounted camera at higher resolution and higher resolution and a higher frame rate compared with the cases of “band small” and “band minimum”.

The adjusting unit 164A controls the sensor information acquiring unit 120A to output the depth information acquired from the Lidar and the Radar to the encoding unit 130A as Full Data without sub-sampling the depth information. When the traveling state of the automobile is “congested”, the band requesting unit 162A reserves a transmission band with a band narrower than “band large” (“in-band”) for the communication unit 140. When the “in-band” transmission band is secured, the adjusting unit 164A controls the sensor information acquiring unit 120A to acquire detection results from all of the sensors 110A of the vehicle-mounted camera, the Lidar, and the Radar.

The adjusting unit 164A controls the sensor information acquiring unit 120A to acquire a captured image (image data) from the vehicle-mounted camera at higher resolution and higher resolution and a higher frame rate compared with the cases of “band small” and “band minimum”.

The adjusting unit 164A controls the sensor information acquiring unit 120A to output the depth information acquired from the Lidar and the Radar mounted on the front of the automobile to the encoding unit 130A as Full Data without sub-sampling the depth information. On the other hand, the adjusting unit 164A controls the sensor information acquiring unit 120A to sub-sample the depth information acquired from the Lidar mounted on the front of the vehicle and the Radars mounted on the sides and the rear of the vehicle and then output the depth information to the encoding unit 130A.

During traffic congestion, it is less likely that vehicles located behind or beside an own vehicle move unless a vehicle ahead or the own vehicle moves. Therefore, the adjusting unit 164A controls the sensor information acquiring unit 120A to acquire information in the front in preparation for the start of the own vehicle and acquire information in the rear and the sides with a limited amount of information. Consequently, the information processing device 10A can suppress an increase in an amount of information to be transmitted and suppress an increase in communication cost while acquiring information around the own vehicle.

When the traveling state of the automobile is “stopped”, the band requesting unit 162A determines that a band necessary for transmission is narrower (“band small”) than “in-band” and does not make a band reservation request. Alternatively, the band requesting unit 162A requests the communication unit 140 to release the secured band. In this case, the adjusting unit 164A controls the sensor information acquiring unit 120A to acquire detection results from the vehicle-mounted camera and the Lidar and the Radar mounted in the front of the automobile and stop acquiring detection results from the other sensors 110A.

The adjusting unit 164A controls the sensor information acquiring unit 120A to acquire a captured image (image data) from the vehicle-mounted camera at lower resolution and a lower frame rate compared with the cases of “band large” and “in band”.

The adjusting unit 164A controls the sensor information acquiring unit 120A to sub-sample the depth information acquired from the Lidar and the Radar mounted in the front of the automobile and output the depth information to the encoding unit 130A.

For example, when the automobile is stopped by a signal or the like, the user requires less information for remote control of the automobile compared with when the automobile is traveling. Therefore, when the automobile is stopped, the information processing device 10A can suppress an increase in an amount of information to be transmitted and suppress an increase in communication cost while stopping information acquisition from some of the sensors 110A and restricting information to be transmitted to acquire information around the own vehicle.

When a state in which the traveling state of the automobile is “stopped” continues for a certain period or longer (long time), the adjusting unit 164A controls the sensor information acquiring unit 120A to stop the information acquisition from the Lidar and the Radar mounted in the front of the automobile. Consequently, the transmission bandwidth used to transmit the traveling information to the terminal device 20A is narrower (band minimum) than “stopping time” before the certain period elapses. For example, when the automobile does not move for a long time such as during parking, information necessary for remotely controlling the automobile decreases compared with when the automobile is stopped by a signal or the like. Therefore, for example, the information processing device 10A can suppress an increase in the amount of information to be transmitted and suppress an increase in communication cost by transmitting minimum information necessary for restarting the driving of the automobile.

In this way, the adjusting unit 164A selects use/stop of the sensors according to priority corresponding to the traveling state of the automobile. When a wideband transmission band is secured for transmission of the sensor information, the information processing device 10A transmits the sensor information acquired from all the sensors to the terminal device 20A. The information processing device 10A performs selection of the sensor information to be transmitted, sub sampling, and the like to reduce an information amount of the sensor information to be transmitted as a bandwidth used for transmission is narrowed. At this time, the information processing device 10A does not uniformly reduce information amounts of all the sensors but adaptively reduces the information amounts as illustrated in FIG. 16, for example, according to a use of the sensor information and the traveling information of the automobile.

This makes it possible to suppress a decrease in safety of remote control while suppressing an increase in communication cost.

<5.3. Operation Example of the Information Processing Device>

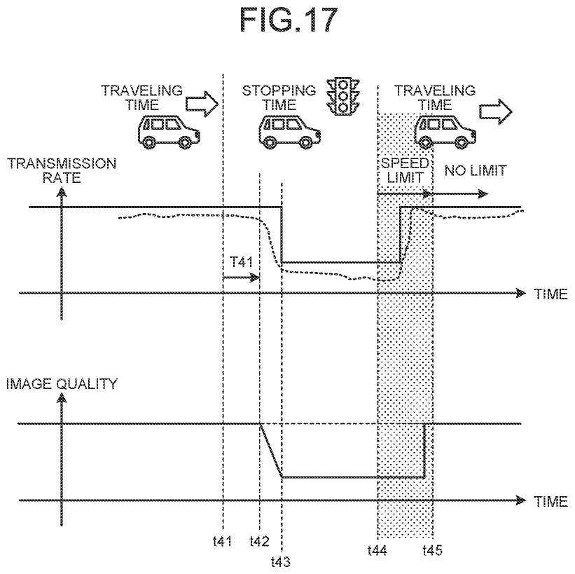

FIG. 17 is a diagram for describing an operation example of the information processing device 10A according to the second embodiment of the present disclosure. Note that, in FIG. 17, a transmission rate available to the information processing device 10A is indicated by a solid line and a transmission rate used by the information processing device 10 for transmitting the traveling information is indicated by a dotted line.

As illustrated in FIG. 17, it is assumed that the automobile on which the information processing device 10A is mounted travels at predetermined speed until time t41 and has speed of “0” at time t41, for example, in order to stop at a traffic light. It is assumed that the signal changes to blue at time t44 and the automobile resumes the traveling.

Until the time t41, the remote control unit 165A of the information processing device 10A notifies the band requesting unit 162A and the adjusting unit 164A that an operation state of the own vehicle is “traveling” while controlling a traveling position, speed, and the like of the own vehicle based on operation information by the user. Note that it is assumed that the band requesting unit 162A has already requested the communication unit 140 to reserve a “band large” transmission band and has secured the “band large” transmission band.

In this case, the adjusting unit 164A controls the sensor information acquiring unit 120A to output information of all of the sensors 110A to the encoding unit 130A without performing processing for reducing an amount of information of sub sampling. Consequently, for example, when the sensor 110A is a vehicle-mounted camera, the information processing device 10A can transmit high-quality traveling information to the terminal device 20A, for example, transmit a captured image with high image quality to the terminal device 20A.

On the other hand, at time t42 when a certain period T41 elapses after the speed of the own vehicle decreases to “0” at the time t41, the remote control unit 165A notifies the band requesting unit 162A and the adjusting unit 164A that the operation state of the own vehicle is “stopped”.

When the own vehicle is “stopped”, the band requesting unit 162A requests the communication unit 140 to open the secured band or reserve a “band small” transmission band. The adjusting unit 164A gradually reduces, for example, resolution and a frame rate of the vehicle-mounted camera until the band is opened at time t43 or the “band small” transmission band is secured. By gradually reducing the resolution and the frame rate in this way, it is possible to make the user less easily feel uncomfortable. When the band is opened at the time t43 or the “band small” transmission band is secured and the transmission rate decreases, the adjusting unit 164A sets resolution and a frame rate adjusted to the decreased transmission rate. Consequently, for example, image quality of a captured image of the vehicle-mounted camera decreases.

Subsequently, for example, at time t44, when operation on the own vehicle from the user or a change in an external environment such as the signal turning blue is detected, the remote control unit 165A changes the operation state of the own vehicle from “stopped” to “traveling” and notifies the change to the band requesting unit 162A and the adjusting unit 164A. Note that the remote control unit 165 may detect the change in the external environment based on, for example, a detection result of the sensor 110A (for example, an image recognition result of a captured image by the vehicle-mounted camera). Alternatively, the terminal device 20A may detect the change in the external environment based on the received traveling information and notify a detection result to the information processing device 10A as operation information.

Note that, as illustrated in FIG. 17, in some case, it takes time from time t44 when the band requesting unit 162A requests reservation of a wideband (band large) transmission band until time t45 when the wideband transmission band is actually secured. In this case, the remote control unit 165A may limit the speed of the own vehicle until, for example, a band is secured and the adjusting unit 164A sets resolution and a frame rate high.

For example, if the remote control unit 165A increases the speed of the own vehicle before the wideband is secured, it is likely that the own vehicle starts before traveling information necessary for vehicle control reaches the terminal device 20A. On the other hand, if the stop state is maintained while the speed of the own vehicle is kept at zero regardless of operation of the user until the wideband is secured, it is likely that the user is considered not to react to the operation and further performs additional operation. For example, when the own vehicle remains stopped even though the user presses an accelerator pedal, there is a possibility that the user further strongly presses the accelerator pedal. When the wideband is secured and the remote control unit 165A receives operation from the user in this state, it is likely that the own vehicle suddenly starts at speed higher than intended by the user.

Therefore, in the example illustrated in FIG. 17, until the time t45 when the wideband transmission band is secured, the remote control unit 165A partially limits operation of the user and, for example, gradually increases the speed or prevents the speed from exceeding predetermined speed. When the wideband is secured at the time t45 and, for example, the image quality of the captured image transmitted to the terminal device 20A recovers to “traveling” before “stop time”, the remote control unit 165A sets the traveling speed of the own vehicle to speed corresponding to the operation of the user. Consequently, the safety of the remote control of the automobile can be improved.

### 6. Third Modification

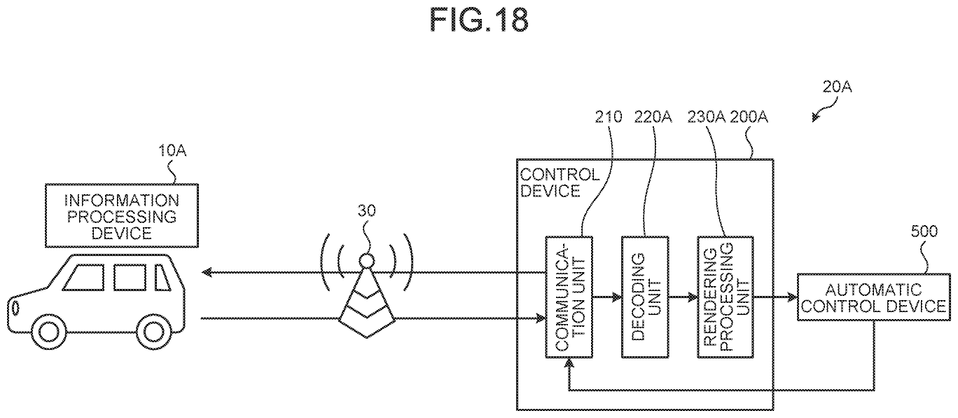

FIG. 18 is a diagram illustrating a configuration example of the information processing device 10A according to a third modification of the present disclosure.

In the second embodiment explained above, the remote control of the automobile is performed by the user but is not limited this. As illustrated in FIG. 18, an automatic control device 500 may perform remote control of the automobile on behalf of the user.

A remote control system according to the present modification is the same as the remote control system illustrated in FIG. 14 except that the remote control system includes the automatic control device 500 instead of the display device 300 and the operation device 400.

In the automatic control device 500, AI (Artificial Intelligence) that automatically drives an automobile from traveling information output by the control device 200A is constructed and performs the remote control of the automobile on behalf of the user.

The automatic control device 500 is configured by, for example, a computer. For example, the automatic control device 500 performs machine learning using traveling information to thereby generate a discriminator and data (model data) to be used by the classifier. AI (for example, AI that automatically drives an automobile) can be realized by such a discriminator and model data. Deep learning can typically be used for the machine learning.

The discriminator can be realized by a neural network. In such a case, the model data can be equivalent to the weight of neurons of the neural network. However, the discriminator may be realized by a device other than the neural network. For example, the discriminator may be realized by a random forest, may be realized by a support vector machine, or may be realized by AdaBoost.

As explained above, when the automatic control device 500 performs the remote control of the automobile, the control device 200a does not always need to output the traveling information in the same format as in the case where the user performs the remote control. For example, rather than outputting a captured image as it is, the control device 200A may output a detection result detected from the captured image such as a pedestrian or another vehicle to the automatic control device 500.

Alternatively, the control device 200A may output the original image data to the automatic control device 500 without performing image processing for the captured image.

### 7. Application Example

As explained above, the technology according to the second embodiment can be realized as, for example, a device mounted on any type of a mobile body such as an automobile, an electric automobile, a hybrid electric automobile, a motorcycle, a bicycle, a personal mobility, an airplane, a drone, a ship, or a robot. A specific application example in a case where the technology according to the second embodiment is mounted on a mobile body is explained.

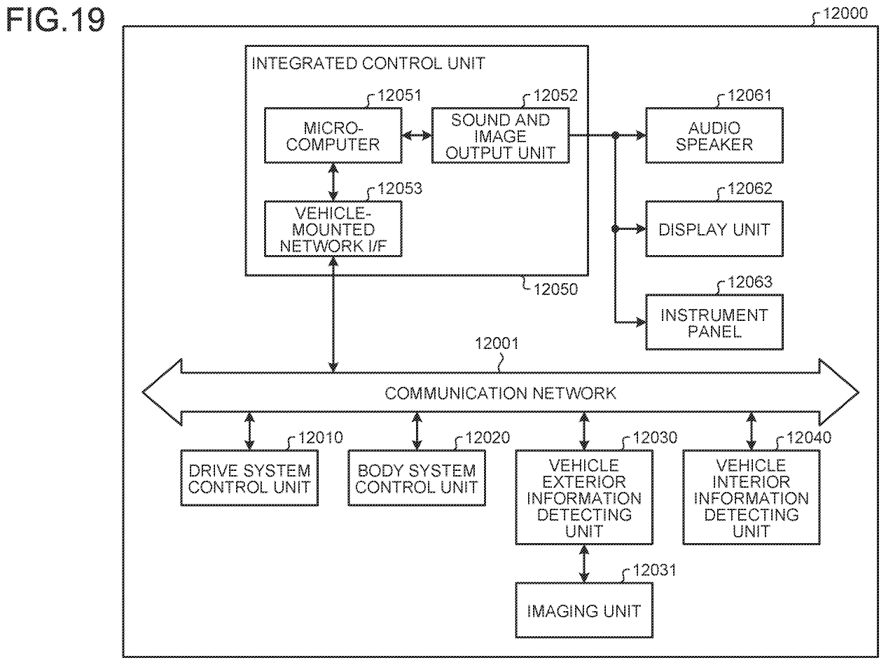

FIG. 19 is a block diagram illustrating a schematic configuration example of a vehicle control system, which is an example of a mobile body control system to which the technique according to the second embodiment of the present disclosure can be applied.

A vehicle control system 12000 includes a plurality of electronic control units connected via a communication network 12001. In the example illustrated in FIG. 19, the vehicle control system 12000 includes a drive system control unit 12010, a body system control unit 12020, a vehicle exterior information detecting unit 12030, and an integrated control unit 12050. As a functional configuration of the integrated control unit 12050, a microcomputer 12051, a sound and image output unit 12052, and a vehicle-mounted network I/F (Interface) 12053 are illustrated.

The drive system control unit 12010 controls operations of devices relating to a drive system of the vehicle according to various programs. For example, the drive system control unit 12010 functions as a control device for a driving force generation device for generating a driving force for the vehicle such as an internal combustion engine or a driving motor, a driving force transmission mechanism for transmitting the driving force to wheels, a steering mechanism for adjusting a steering angle of the vehicle, and a braking device for generating a braking force for the vehicle.

The body system control unit 12020 controls operations of various devices mounted on a vehicle body according to various programs. For example, the body system control unit 12020 functions as a control device for a keyless entry system, a smart key system, a power window device, or various lamps such as a head lamp, a back lamp, a brake lamp, a blinker, or a fog lamp. In this case, radio waves transmitted from a portable device substituting for a key or signals of various switches can be input to the body system control unit 12020. The body system control unit 12020 receives inputs of these radio waves or signals and controls the door lock device, the power window device, the lamps, and the like of the vehicle.

The vehicle exterior information detecting unit 12030 detects information on the outside of the vehicle on which the vehicle control system 12000 is mounted. For example, an imaging unit 12031 is connected to the vehicle exterior information detecting unit 12030. The vehicle exterior information detecting unit 12030 causes the imaging unit 12031 to capture an image on the outside of the vehicle and receives the captured image. The vehicle exterior information detecting unit 12030 may perform object detection processing or distance detection processing for a person, a vehicle, an obstacle, a sign, a character on a road surface, or the like based on the received image.

The imaging unit 12031 is an optical sensor that receives light and outputs an electric signal corresponding to an amount of the received light. The imaging unit 12031 can output the electric signal as an image or can output the electric signal as distance measurement information. The light received by the imaging unit 12031 may be visible light or may be invisible light such as infrared rays.

The microcomputer 12051 can calculate a control target value of the driving force generation device, the steering mechanism, or the braking device based on the information on the outside of the vehicle acquired by the vehicle exterior information detecting unit 12030 and output a control command to the drive system control unit 12010. For example, the microcomputer 12051 can perform cooperative control for the purpose of realizing functions of an ADAS (Advanced Driver Assistance System) including collision avoidance or impact mitigation for the vehicle, following traveling based on an inter-vehicle distance, vehicle speed maintenance traveling, vehicle collision warning, or vehicle lane departure warning.

By controlling the driving force generation device, the steering mechanism, the braking device, or the like based on information around the vehicle acquired by the vehicle exterior information detecting unit 12030, the microcomputer 12051 can perform the cooperative control for the purpose of automatic driving or the like in which a vehicle autonomously travels without depending on operation of a driver.

The microcomputer 12051 can output a control command to the body system control unit 12020 based on the vehicle exterior information acquired by the vehicle exterior information detecting unit 12030. For example, the microcomputer 12051 can control the head lamp according to the position of a preceding vehicle or an oncoming vehicle detected by the vehicle exterior information detecting unit 12030 and perform cooperative control for the purpose of preventing glare such as switching from a high beam to a low beam.

The sound and image output unit 12052 transmits an output signal of at least one of sound or an image to an output device capable of visually or audibly notifying information to an occupant of the vehicle or the outside of the vehicle. In the example illustrated in FIG. 19, an audio speaker 12061, a display unit 12062, and an instrument panel 12063 are illustrated as the output device. The display unit 12062 may include, for example, at least one of an on-board display and a head-up display.

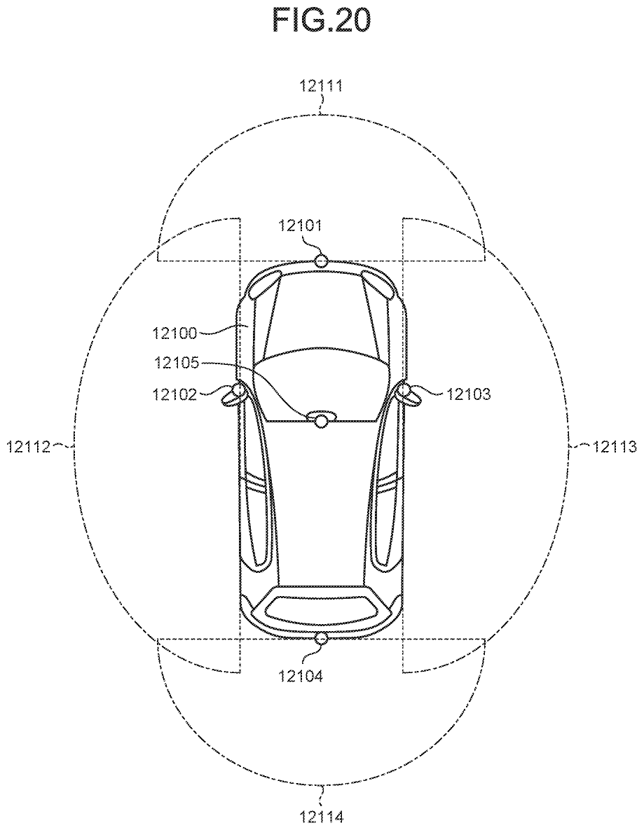

FIG. 20 is a diagram illustrating an example of a setting position of the imaging unit 12031.

In FIG. 20, a vehicle 12100 includes imaging units 12101, 12102, 12103, 12104, and 12105 as the imaging unit 12031.

The imaging units 12101, 12102, 12103, 12104, and 12105 are provided, for example, in positions such as a front nose, side mirrors, a rear bumper, a back door, and an upper portion of a windshield in a vehicle interior of the vehicle 12100. The imaging unit 12101 provided in the front nose and the imaging unit 12105 provided in the upper portion of the windshield in the vehicle interior mainly acquire images in the front of the vehicle 12100. The imaging units 12102 and 12103 provided in the side mirrors mainly acquire images on the sides of the vehicle 12100. The imaging unit 12104 provided in the rear bumper or the back door mainly acquires an image behind the vehicle 12100. Front images acquired by the imaging units 12101 and 12105 are mainly used for detecting a preceding vehicle, a pedestrian, an obstacle, a traffic light, a traffic sign, a lane, or the like.

Note that, in FIG. 20, an example of imaging ranges of the imaging units 12101 to 12104 is illustrated. An imaging range 12111 indicates an imaging range of the imaging unit 12101 provided in the front nose, imaging ranges 12112 and 12113 respectively indicate imaging ranges of the imaging units 12102 and 12103 provided in the side mirrors, and an imaging range 12114 indicates an imaging range of the imaging unit 12104 provided in the rear bumper or the back door. For example, a bird's-eye view image of the vehicle 12100 viewed from above is obtained by superimposing image data captured by the imaging units 12101 to 12104.

At least one of the imaging units 12101 to 12104 may have a function of acquiring distance information. For example, at least one of the imaging units 12101 to 12104 may be a stereo camera including a plurality of imaging elements or may be an imaging element including pixels for phase difference detection.

For example, by obtaining distances to three-dimensional objects in the imaging ranges 12111 to 12114 and temporal changes of the distances (relative speed with respect to the vehicle 12100) based on distance information obtained from the imaging units 12101 to 12104, the microcomputer 12051 can extract, as a preceding vehicle, in particular, a closest three-dimensional object present on a traveling path of the vehicle 12100, the three-dimensional object traveling at predetermined speed (for example, 0 km/h or more) in substantially the same direction as the vehicle 12100. Further, the microcomputer 12051 can set an inter-vehicle distance that should be secured in advance in the front of the preceding vehicle and perform automatic brake control (including following stop control), automatic acceleration control (including following start control), and the like. As explained above, it is possible to perform cooperative control for the purpose of automatic driving or the like in which the vehicle autonomously travels without depending on the operation of the driver.

For example, based on the distance information obtained from the imaging units 12101 to 12104, the microcomputer 12051 can classify three-dimensional object data concerning three-dimensional objects into two-wheeled vehicles, ordinary vehicles, large vehicles, pedestrians, and other three-dimensional objects such as utility poles, extract the three-dimensional object data, and use the three-dimensional object data for automatic avoidance of obstacles. For example, the microcomputer 12051 classifies obstacles around the vehicle 12100 into obstacles that the driver of the vehicle 12100 can visually recognize and obstacles that the driver has difficulty in visually recognizing. The microcomputer 12051 can determine a collision risk indicating a risk of collision with the obstacles and, when the collision risk is a set value or more and there is a possibility of collision, perform driving assistance for collision avoidance by outputting an alarm to the driver via the audio speaker 12061 or the display unit 12062 or performing forced deceleration or avoidance steering via the drive system control unit 12010.

At least one of the imaging units 12101 to 12104 may be an infrared camera that detects infrared rays. For example, the microcomputer 12051 can recognize a pedestrian by determining whether the pedestrian is present in captured images of the imaging units 12101 to 12104. Such pedestrian recognition is performed by, for example, a procedure for extracting feature points in the captured images of the imaging units 12101 to 12104 functioning as infrared cameras and a procedure for performing pattern matching processing on a series of feature points indicating the contour of an object to discriminate whether the object is a pedestrian. When the microcomputer 12051 determines that a pedestrian is present in the captured images of the imaging units 12101 to 12104 and recognizes the pedestrian, the sound and image output unit 12052 controls the display unit 12062 to superimpose and display a square contour line for emphasis on the recognized pedestrian. The sound and image output unit 12052 may control the display unit 12062 to display an icon or the like indicating the pedestrian in a desired position.

### 8. Supplementation

The preferred embodiments of the present disclosure are explained in detail above with reference to the accompanying drawings. However, the technical scope of the present disclosure is not limited to such examples. It is evident that those having the ordinary knowledge in the technical field of the present disclosure can arrive at various alterations or corrections within the category of the technical idea described in claims. It is understood that these alterations and corrections naturally belong to the technical scope of the present disclosure.

Among the processing explained in the above embodiments, all or a part of the processing explained as being automatically performed can be manually performed or all or a part of the processing explained as being manually performed can be automatically performed by a publicly-known method. Besides, the processing procedure, the specific names, and the information including the various data and parameters described in the document and the drawings can be optionally changed except when specifically noted otherwise. For example, the various kinds of information illustrated in the figures are not limited to the illustrated information.

The components of the devices illustrated in the drawings are functionally conceptual and are not always required to be physically configured as illustrated in the drawings. That is, specific forms of distribution and integration of the devices are not limited to the illustrated forms and all or a part thereof can be functionally or physically distributed and integrated in any unit according to various loads, usage situations, and the like.

The embodiments explained above can be combined as appropriate within a range in which the processing contents do not contradict one another.

The effects described in this specification are only explanatory or illustrative and are not limiting. That is, the technique according to the present disclosure can achieve other effects obvious to those skilled in the art from the description of this specification together with the effects or instead of the effects.

Note that the following configurations also belong to the technical scope of the present disclosure.

(1)

An information processing device comprising:

a band requesting unit that requests, according to a bandwidth necessary for transmission of information including a moving image, use reservation of the bandwidth;

an adjusting unit that adjusts, according to a reserved bandwidth as a result of the request by the band requesting unit, an information amount of the information to be transmitted; and

a transmitting unit that converts the information with the adjusted information amount into a transmission signal and transmits the transmission signal.

(2)

The information processing device according to (1), further comprising a drawing unit that performs rendering of the moving image, wherein

the adjusting unit adjusts the information amount of the information output from the drawing unit.

(3)

The information processing device according to (2), wherein

the information is moving image information transmitted by execution of an application, and

the band requesting unit requests the use reservation for the bandwidth according to an operation state of the application.

(4)

The information processing device according to (3), wherein the band requesting unit requests the use reservation for the bandwidth when a scene of the application is changed.

(5)

The information processing device according to (3) or (4), wherein the band requesting unit requests the use reservation for the bandwidth according to a notification indicating failure in acquisition of the information from a transmission partner of the information.

(6)

The information processing device according to any one of (3) to (5), wherein the band requesting unit determines, according to the information amount of the information, the bandwidth for which the use reservation is requested.

(7)

The information processing device according to any one of (3) to (6), wherein the band requesting unit determines, according to the information amount of the information requested by a transmission partner of the information, the bandwidth for which the use reservation is requested.

(8)

The information processing device according to any one of (3) to (7), wherein the band requesting unit determines, according to a response state to the application by a communication partner of the information, the bandwidth for which the use reservation is requested.

(9)

The information processing device according to any one of (3) to (8), wherein the adjusting unit adjusts at least one of resolution and a frame rate of the moving image.

(10)

The information processing device according to (1), wherein the information processing device is a device that transmits the information to a control device that remotely controls a control target, and

the band requesting unit determines, according to an operation state of the control target, the bandwidth for which the use reservation is requested.

(11)

The information processing device according to (10), wherein

the information includes a plurality of sensing results by a plurality of sensors mounted on the control target, and

the adjusting unit adjusts a number of the sensing results transmitted by the transmitting unit.

(12)

The information processing device according to (10) or (11), wherein

the information includes an imaging result of a moving image by an imaging device mounted on the control target, and

the adjusting unit adjusts at least one of resolution and a frame rate of the moving image.

(13)

An information processing system comprising:

a transmitting device including:

a band requesting unit that requests, according to a bandwidth necessary for transmission of information including a moving image, use reservation of the bandwidth;

an adjusting unit that adjusts, according to a reserved bandwidth as a result of the request by the band requesting unit, an information amount of the information to be transmitted; and

a transmitting unit that converts the information with the adjusted information amount into a transmission signal and transmits the transmission signal; and

a receiving device including:

a receiving unit that receives the information; and

a drawing unit that renders a moving image included in the information.

14)

An information processing method comprising: requesting, according to a bandwidth necessary for transmission of information including a moving image, use reservation of the bandwidth;

adjusting, according to a reserved bandwidth as a result of the request by the band requesting unit, an information amount of the information to be transmitted; and

converting the information with the adjusted information amount into a transmission signal and transmitting the transmission signal.

### REFERENCE SIGNS LIST

10, 10A INFORMATION PROCESSING DEVICE
20, 20A TERMINAL DEVICE
30 BASE STATION DEVICE
110 APPLICATION UNIT
110A SENSOR
120 RENDERING PROCESSING UNIT
120A SENSOR INFORMATION ACQUIRING UNIT
130, 130A ENCODING UNIT
140 COMMUNICATION UNIT
150 ACQUIRING UNIT
160, 160A CONTROL UNIT
161, 161A INSERTION DETERMINING UNIT
162, 162A BAND REQUESTING UNIT
163, 163A BAND INFORMATION ACQUIRING UNIT
164, 164A ADJUSTING UNIT
165A REMOTE CONTROL UNIT
210 COMMUNICATION UNIT
220, 220A DECODING UNIT
230 RENDERING PROCESSING UNIT
230A DISPLAY CONTROL UNIT
240 OPERATION ACQUIRING UNIT
300 DISPLAY DEVICE
400, 400A OPERATION DEVICE
500 AUTOMATIC CONTROL DEVICE

1. An information processing device comprising:
a band requesting unit that requests, according to a bandwidth necessary for transmission of information including a moving image, use reservation of the bandwidth;
an adjusting unit that adjusts, according to a reserved bandwidth as a result of the request by the band requesting unit, an information amount of the information to be transmitted; and
a transmitting unit that converts the information with the adjusted information amount into a transmission signal and transmits the transmission signal.

2. The information processing device according to claim 1, further comprising a drawing unit that performs rendering of the moving image, wherein
the adjusting unit adjusts the information amount of the information output from the drawing unit.

3. The information processing device according to claim 2, wherein
the information is moving image information transmitted by execution of an application, and
the band requesting unit requests the use reservation for the bandwidth according to an operation state of the application.

4. The information processing device according to claim 3, wherein the band requesting unit requests the use reservation for the bandwidth when a scene of the application is changed.

5. The information processing device according to claim 3, wherein the band requesting unit requests the use reservation for the bandwidth according to a notification indicating failure in acquisition of the information from a transmission partner of the information.

6. The information processing device according to claim 3, wherein the band requesting unit determines, according to the information amount of the information, the bandwidth for which the use reservation is requested.

7. The information processing device according to claim 3, wherein the band requesting unit determines, according to the information amount of the information requested by a transmission partner of the information, the bandwidth for which the use reservation is requested.

8. The information processing device according to claim 3, wherein the band requesting unit determines, according to a response state to the application by a communication partner of the information, the bandwidth for which the use reservation is requested.

9. The information processing device according to claim 3, wherein the adjusting unit adjusts at least one of resolution and a frame rate of the moving image.

10. The information processing device according to claim 1, wherein the information processing device is a device that transmits the information to a control device that remotely controls a control target, and
the band requesting unit determines, according to an operation state of the control target, the bandwidth for which the use reservation is requested.

11. The information processing device according to claim 10, wherein
the information includes a plurality of sensing results by a plurality of sensors mounted on the control target, and
the adjusting unit adjusts a number of the sensing results transmitted by the transmitting unit.

12. The information processing device according to claim 10, wherein
the information includes an imaging result of a moving image by an imaging device mounted on the control target, and
the adjusting unit adjusts at least one of resolution and a frame rate of the moving image.

13. An information processing system comprising:
a transmitting device including:
a band requesting unit that requests, according to a bandwidth necessary for transmission of information including a moving image, use reservation of the bandwidth;
an adjusting unit that adjusts, according to a reserved bandwidth as a result of the request by the band requesting unit, an information amount of the information to be transmitted; and
a transmitting unit that converts the information with the adjusted information amount into a transmission signal and transmits the transmission signal; and
a receiving device including:
a receiving unit that receives the information; and
a drawing unit that renders a moving image included in the information.

14. An information processing method comprising:
requesting, according to a bandwidth necessary for transmission of information including a moving image, use reservation of the bandwidth;
adjusting, according to a reserved bandwidth as a result of the request by the band requesting unit, an information amount of the information to be transmitted; and
converting the information with the adjusted information amount into a transmission signal and transmitting the transmission signal.
